(19) United States
(12) Patent Application Publication
(10) Pub. No.: US 2025/0139824 A1
(43) Pub. Date: May 1, 2025

(54) MODELING, DRIFT DETECTION AND DRIFT CORRECTION FOR VISUAL INERTIAL ODOMETRY

(71) Applicant: Hover, Inc., San Francisco, CA (US)

(72) Inventors: Hongyuan He, San Francisco, CA (US); Manlio Francisco Barajas Hernandez, San Francisco, CA (US); Atulya Shree, San Francisco, CA (US)

(21) Appl. No.: 18/934,023

(22) Filed: Oct. 31, 2024

Related U.S. Application Data
(60) Provisional application No. 63/595,186, filed on Nov. 1, 2023.
(60) Provisional application No. 63/604,759, filed on Nov. 30, 2023.
(60) Provisional application No. 63/714,106, filed on Oct. 30, 2024.
(60) Provisional application No. 63/714,116, filed on Oct. 30, 2024.

(51) Int. Cl. G06T 7/73; G06T 7/246; G06T 7/33; G06T 17/20; G06T 19/00; G06T 19/20

(52) U.S. Cl. CPC G06T 7/74; G06T 7/248; G06T 7/337; G06T 17/20; G06T 19/006; G06T 19/20; G06T 2200/24; G06T 2207/30244; G06T 2210/56; G06T 2219/2004

(57) ABSTRACT

System and method are provided for improving camera pose accuracy in augmented reality (AR) systems. The method detects and processes inconsistencies in captured camera poses by identifying locally rigid pose groups and matching visual features between images both within and across these groups. The process involves triangulating 3D landmarks within pose groups, establishing correspondences between groups, and performing bundle adjustment to optimize camera poses. This systematic approach enables the generation of accurate 3D models by detecting and correcting pose drift through feature matching, landmark triangulation, and global pose optimization across multiple camera positions and orientations.

### RELATED APPLICATIONS

This application claims priority to U.S. Provisional Patent Application No. 63/595,186, filed Nov. 1, 2023, entitled “Modeling, Drift Detection and Drift Correction for Visual Inertial Odometry,” U.S. Provisional Patent Application No. 63/604,759, filed Nov. 30, 2023, entitled “Modeling, Drift Detection and Drift Correction for Visual Inertial Odometry,” U.S. Provisional Patent Application No. 63/714,106, filed Oct. 30, 2024, entitled “Modeling, Drift Detection and Drift Correction for Visual Inertial Odometry,” U.S. Provisional Patent Application No. 63/714,116, filed Oct. 30, 2024, entitled “Modeling, Drift Detection and Drift Correction for Visual Inertial Odometry,” each of which is incorporated by reference herein in its entirety.

### TECHNICAL FIELD

The disclosed implementations relate generally to 3-D reconstruction and more specifically to systems and methods for modeling, drift detection and correction for visual inertial odometry.

### BACKGROUND

3-D building models and visualization tools can produce significant cost savings. Using accurate 3-D models of properties, homeowners, for instance, can estimate and plan every project. With near real-time feedback, contractors could provide customers with instant quotes for remodeling projects. Interactive tools can enable users to view objects (e.g., buildings) under various conditions (e.g., at different times, under different weather conditions). Some 3-D building modeling tools model an interior floorplan using a sequence of images. Some tools use posed cameras from visual inertial odometry (VIO) systems or other camera solvers. Visual odometry is the process of determining the position and orientation of an object by analyzing the associated camera images. VIO uses visual odometry to estimate pose from camera images, combined with inertial measurements from an inertial measurement unit (IMU), to correct for errors, such as errors associated with rapid movement resulting in poor image capture. Camera poses from a VIO system, such as ARKit or ARCore, may have good initial relative poses. However, the camera poses may drift over time. Inertial sensors in a VIO system are useful for pose estimation in the short term but tend to drift over time in the absence of global pose measurements or constraints. VIO systems can provide useful initialization for solving camera poses and can indicate which image pairs to use for feature matching. However, occasional drifts in tracking can occur, even when most poses are relatively correct to each other. Detecting and correcting this drift allows for better utilization of the tracking data.

### SUMMARY

Accordingly, there is a need for systems and methods for modeling, drift detection, and correction for visual inertial odometry (VIO) methods. The problem of variability in covisible features for bundle adjustment is solved by grouping camera poses according to relative positions and adjusting a single camera pose in the group according to a camera pose in another group. A transform may be applied to a new group of camera poses that aligns a first camera pose in the new group of camera poses to geometry observed by that first camera pose, wherein the geometry may be generated according to one or more camera poses of one or more other (i.e., preceding) groups of camera poses. Some implementations detect a drift in camera poses based on an observed misalignment, create a new group of camera poses (poses temporally subsequent to that misaligned camera pose), correct that one misaligned camera pose, and apply the same transformation to the rest of the camera poses. Some implementations continue modeling until a drift is detected, and create a new group of subsequent cameras and adjust drift for that group based on the newly detected drift camera. Because drift in later cameras is worse than earlier cameras, a drift correction to earlier cameras will not solve for drift in later cameras.

Some implementations detect discontinuities or inconsistencies associated with the sequence of camera poses (sometimes referred to as detecting drifts in the camera poses) to identify locally rigid pose groups. This can involve detecting changes in tracking session identification (ID), tracking session state, translational and/or rotational acceleration, translational and/or rotational velocities, and the like. In some implementations, the system handles poses differently within and across pose groups. Within a locally rigid pose group, pairs of poses are generated and features are matched between these pairs, followed by triangulating 3D landmarks. For poses across different locally rigid pose groups, features are matched between pairs of poses. To register groups together, correspondences are found between 3D landmarks from one group and 2D observations in another group, using perspective-n-point for registration. Bundle adjustment is then performed using relative pose priors within the same pose group.

In one aspect, a method is provided for detecting and correcting drift in camera poses. The method includes obtaining a plurality of images, a set of camera poses associated with the plurality of images, and a model for a building. The method also includes detecting inconsistencies associated with at least one camera pose of the set of camera poses based on visual data of at least one associated image and the model observed from the at least one camera pose. The method also includes creating a subset of camera poses including the at least one camera pose. The method also includes correcting the inconsistencies associated with the at least one camera pose by generating at least one image markup on the visual data of the at least one associated image, and adjusting one or more camera parameters of the at least one camera pose to substantially align the at least one image markup to the model. The method also includes applying the one or more adjusted camera parameters to the other camera poses in the subset of camera poses.

In some implementations, detecting inconsistencies associated with the at least one camera pose includes detecting a change in tracking session identification associated with the plurality of captured camera poses.

In some implementations, detecting inconsistencies associated with the at least one camera pose includes detecting a change in tracking session state associated with the plurality of captured camera poses.

In some implementations, detecting inconsistencies associated with the at least one camera pose includes detecting a translational acceleration exceeding a translational acceleration threshold.

In some implementations, the translational acceleration threshold is five meters per second squared.

In some implementations, detecting inconsistencies associated with the at least one camera pose includes detecting a rotational acceleration exceeding a rotational acceleration threshold.

In some implementations, the rotational acceleration threshold is ten radians per second squared.

In some implementations, detecting inconsistencies associated with the at least one camera pose includes detecting a translational velocity exceeding a translational velocity threshold.

In some implementations, the translation velocity threshold is two meters per second.

In some implementations, detecting inconsistencies associated with the at least one camera pose includes detecting a rotational velocity exceeding a rotational velocity threshold.

In some implementations, the rotational velocity threshold is three radians per second.

In some implementations, detecting inconsistencies associated with the at least one camera pose includes detecting a projection difference of more than 30 pixels between the visual data of the at least one associated image and the model observed from the at least one camera pose.

In some implementations, generating at least one image markup further includes corresponding the at least one image markup with 3D elements of the model.

In some implementations, camera poses within the subset have a unique group offset transform for defining where the subset should be placed in a world space.

In some implementations, a maximum number of created subsets is a number of camera poses in the set of camera poses.

In some implementations, detecting inconsistencies is based on temporal ordering of the camera poses.

In some implementations, detecting inconsistencies and modeling are performed in an iterative manner.

In some implementations, the method further includes generating new parts of the model based on one or more camera poses of the subset of camera poses.

In some implementations, the set of camera poses are obtained from a visual inertial odometry system.

In some implementations, the set of camera poses are defined in a relative coordinate system.

In some implementations, the method further includes using an initialization process to orient an initial group of camera poses of the set of camera poses to a Manhattan modeling system, to obtain a Manhattan offset, and subsequently propagating the Manhattan offset to other camera poses of the set of camera poses.

In some implementations, the model includes a number of corners, walls, and openings, a number of corners connected to each other as part of a wall, points having Manhattan constraints, and an initial estimate of corner locations.

In some implementations, the at least one image markup is obtained as user input via a user interface.

In some implementations, the method further includes creating an additional subset of camera poses when new drift is detected in an additional camera within the subset of camera poses.

In some implementations, the method further includes correcting accuracy issues in the at least one image markup by computing covariances of estimated points.

In some implementations, the method further includes obtaining multiple image markups on the visual data of the at least one associated image, and distributing the multiple image markups around the visual data to avoid overfitting when markups are in one place in which case data is likely biased towards that region.

In some implementations, the method further includes obtaining multiple image markups on visual data of multiple images associated with the subset of camera poses, and applying markups that identify features observed in more than one image, such that camera parameter adjustments are not biased towards features that are not observed in other images.

In some implementations, the constrained degree of freedom is based on a gravity vector associated with the at least one camera.

In some implementations, the constrained degree of freedom is based on a rotation vector associated with the at least one camera.

In some implementations, the model includes a geometric model.

In some implementations, the model includes a point cloud.

In some implementations, the model includes a line cloud.

In some implementations, the one or more other camera parameter include translation.

In some implementations, the one or more other camera parameter include rotation.

In some implementations, adjusting the one or more camera parameters includes constraining at least one degree of freedom of the at least one camera pose and adjusting camera parameters other than the at least one degree of freedom.

In another aspect, a method is provided for detecting and correcting drifts in camera poses, according to some implementations. The method includes obtaining a plurality of images and a plurality of captured camera poses associated with the plurality of images from an augmented reality (AR) tracking system. The method includes detecting inconsistencies associated with the plurality of captured camera poses (sometimes referred to as detecting drifts in the camera poses) to identify locally rigid captured camera pose groups. The method includes detecting features in the plurality of images. The method includes matching features between the plurality of images. For captured camera poses in a locally rigid captured camera pose group, the method generates pairs of captured camera poses in the locally rigid captured camera pose group and matches features between the pairs of captured camera poses. For captured camera poses across locally rigid captured camera pose groups, the method generates pairs of captured camera poses and matches features between the pairs of captured camera poses. Within each locally rigid captured camera pose group, the method triangulates three-dimensional (3D) landmarks. Each landmark includes a 3D point and a plurality of 2D points of images that correspond to the 3D point. For a pair of locally rigid captured camera pose groups that includes a first group of locally rigid captured camera poses and a second group of locally rigid camera poses, the method determines correspondences between 3D landmarks of the first group and two-dimensional (2D) observations of same features in the second group. The method registers the second group to the first group based on perspective-n-point. The method performs bundle adjustment of captured camera poses within and across registered groups of locally rigid captured camera pose groups. The method generates a 3D model based on the adjusted camera poses.

In some implementations, detecting inconsistencies includes detecting a change in tracking session identification associated with the plurality of captured camera poses. In some implementations, detecting inconsistencies includes detecting a change in tracking session state associated with the plurality of captured camera poses.

In some implementations, detecting inconsistencies includes detecting a translational acceleration exceeding a translational acceleration threshold, such as five meters per second squared. In some implementations, detecting inconsistencies includes detecting a rotational acceleration exceeding a rotational acceleration threshold, such as ten radians per second squared.

In some implementations, detecting inconsistencies includes detecting a translational velocity exceeding a translational velocity threshold, such as two meters per second. In some implementations, detecting inconsistencies includes detecting a rotational velocity exceeding a rotational velocity threshold, such as three radians per second.

In some implementations, performing bundle adjustment within registered groups of locally rigid captured camera pose groups includes using relative pose priors within the same group.

In some implementations, performing bundle adjustment includes using captured camera poses of the locally rigid captured camera pose groups as enhanced priors in the bundle adjustment process.

In some implementations, the method further includes providing an interface for manual restoration of the 3D model. The interface includes reconstructing and loading multiple point clouds separately.

In some implementations, the interface for manual restoration includes tools for adjusting positions of separate point clouds corresponding to different pose groups.

In some implementations, the method further includes meshing the triangulated points to create a 3D surface model.

In some implementations, a system including one or more processors, and one or more non-transitory computer-readable storage media storing instructions, which when executed by the one or more processors, causes the system to carry out the method of any one of the preceding implementations.

In some implementations, one or more non-transitory computer-readable storage media carrying machine-readable instructions, which when executed by one or more processors of one or more machines, cause the one or more machines to carry out the method of any one of the preceding examples.

In another aspect, a method is provided for detecting and correcting drifts in camera poses, according to some implementations. The method includes obtaining a plurality of captured images, a plurality of captured camera poses associated with the plurality of captured images from an augmented reality (AR) tracking system, and a plurality of solved camera poses. The method includes detecting inconsistencies associated with the plurality of captured camera poses (sometimes referred to as detecting drifts in the camera poses) to identify locally rigid captured camera pose groups. The method includes aligning the locally rigid captured camera pose groups based on the plurality of solved camera poses.

In some implementations, the plurality of solved camera poses are associated with a 3D model.

In some implementations, the 3D model includes a parametric model, a point cloud, a mesh model, or the like.

In some implementations, the plurality of solved camera poses includes a plurality of camera pose estimates. In some implementations, the plurality of solved camera poses are based on the plurality of captured camera poses. In some implementations, the plurality of solved camera poses includes a subset of the plurality of captured camera poses. In some implementations, the plurality of solved camera poses includes a modified version of the plurality of captured camera poses.

In some implementations, the modifications include one or more of position, orientation, and camera intrinsics.

In some implementations, the plurality of captured camera poses are temporally sequenced.

In some implementations, detecting inconsistencies includes detecting a change in tracking session identification associated with the plurality of captured camera poses. In some implementations, detecting inconsistencies includes detecting a change in tracking session state associated with the plurality of captured camera poses.

In some implementations, detecting inconsistencies includes detecting a translational acceleration exceeding a translational acceleration threshold, such as five meters per second squared. In some implementations, detecting inconsistencies includes detecting a rotational acceleration exceeding a rotational acceleration threshold, such as ten radians per second squared.

In some implementations, detecting inconsistencies includes detecting a translational velocity exceeding a translational velocity threshold, such as two meters per second. In some implementations, detecting inconsistencies includes detecting a rotational velocity exceeding a rotational velocity threshold, such as three radians per second.

In some implementations, aligning the locally rigid captured camera pose groups includes aligning each locally rigid captured camera pose group to the plurality of solved camera poses.

In some implementations, aligning the locally rigid captured camera pose groups includes performing operations for each locally rigid captured camera pose group. The operations include identifying corresponding solved camera poses of the plurality of solved camera poses. The operations include generating a transform for aligning the locally rigid captured camera pose group to the corresponding solved camera poses. The operations include applying the transform to the locally rigid captured camera pose group to align the locally rigid camera pose group to the corresponding solved camera poses.

In some implementations, the transform includes a similarity transform between a world coordinate system of the locally rigid captured camera pose group and a world coordinate system of the plurality of solved camera poses.

In some implementations, the similarity transform includes one or more of rotation, translation, and scaling.

In some implementations, the method further includes generating a 3D model based on the aligned locally rigid captured camera pose groups.

In some implementations, the 3D model includes a parametric model, a point cloud, a mesh model, or the like.

In some implementations, the method further includes obtaining a model. The method detects drift in at least one camera pose of an aligned locally rigid captured camera pose group. The method corrects the drift of the at least one camera pose based on the model.

In some implementations, a system including one or more processors, and one or more non-transitory computer-readable storage media storing instructions, which when executed by the one or more processors, causes the system to carry out the method of any one of the preceding implementations.

In some implementations, one or more non-transitory computer-readable storage media carrying machine-readable instructions, which when executed by one or more processors of one or more machines, cause the one or more machines to carry out the method of any one of the preceding examples.

In another aspect, a method is provided for correcting drifts in a sequence of images. The method includes obtaining a set of images and a geometry for a building structure. The method also includes detecting a misalignment between modeled lines and lines based on an image. The method also includes, in response to detecting the misalignment, correcting a drift so that a reprojection error as determined from a first misaligned camera pose is minimized, including applying a transform to the first misaligned camera pose, and propagating the transform to all subsequent camera poses following the first misaligned camera pose.

In some implementations, the detecting the misalignment, correcting the drift, and propagating the drift, are performed while building the geometry.

In some implementations, the method further includes continuing modeling until the geometry starts to misalign as determined from a second misaligned camera pose and thereafter creating a new group of camera poses following the second misaligned camera pose, and repeating the correcting the drift and propagating the transform for all subsequent camera poses.

In some implementations, a system including one or more processors, and one or more non-transitory computer-readable storage media storing instructions, which when executed by the one or more processors, causes the system to carry out the method of any one of the preceding implementations.

In some implementations, one or more non-transitory computer-readable storage media carrying machine-readable instructions, which when executed by one or more processors of one or more machines, cause the one or more machines to carry out the method of any one of the preceding examples.

In another aspect, a computer system includes one or more processors, memory, and one or more programs stored in the memory. The programs are configured for execution by the one or more processors. The programs include instructions for performing any of the methods described herein.

In another aspect, a non-transitory computer readable storage medium stores one or more programs configured for execution by one or more processors of a computer system. The programs include instructions for performing any of the methods described herein.

### BRIEF DESCRIPTION OF THE DRAWINGS

FIG. 1 is a schematic diagram of a computing system for drift detection and correction, in accordance with some implementations.

FIG. 2A is a block diagram of a computing device for drift detection and correction, in accordance with some implementations.

FIG. 2B is a block diagram of a device capable of capturing images, in accordance with some implementations.

FIG. 3 is a schematic diagram of example drifts for camera poses, according to some implementations.

FIG. 4A is a schematic diagram of example camera poses with drastic drift errors, according to some implementations.

FIG. 4B is a schematic diagram of example camera poses with gradual drift errors, according to some implementations.

FIG. 4C is a schematic diagram of example camera poses after drift correction, according to some implementations.

FIG. 4D is a schematic diagram of example initial poses for drift detection and correction, according to some implementations.

FIG. 4E is a schematic diagram of example initialization for drift detection and correction, according to some implementations.

FIG. 4F is a schematic diagram of example drift detection and correction, according to some implementations.

FIG. 4G is a schematic diagram of example modeling parts of a geometry using corrected cameras, according to some implementations.

FIG. 4H is a schematic diagram of example iterative drift detection and correction, according to some implementations.

FIG. 4I is a schematic diagram of example iterative drift detection and correction, according to some implementations.

FIG. 5 is a block diagram of an example system for modeling and drift correction, according to some implementations.

FIG. 6 is a flowchart of an example method for detecting and correcting drift in camera poses, in accordance with some implementations.

FIG. 7 is a flowchart of another example method for drift detection and correction, in accordance with some implementations.

FIG. 8 is a schematic diagram illustrating the use of AR poses for registering a first set of poses with a second set of poses, according to some implementations.

FIG. 9 is a schematic diagram illustrating an example of a case of camera pose alignment, according to some implementations.

FIG. 10 is a schematic diagram illustrating the challenges of AR tracking drift in pose registration between pose sets, according to some implementations.

FIG. 11 illustrates example methods for detecting AR tracking drifts in captures, according to some implementations.

FIG. 12 illustrates an example method for AR drift detection using tracking session identifier, according to some implementations.

FIG. 13 illustrates example methods for AR drift detection, according to some implementations.

FIG. 14 is a schematic diagram of an example process for estimating a correct pose, according to some embodiments.

FIGS. 15A-15C illustrate an example application of drift detection using locally rigid pose groups, according to some implementations.

FIG. 16 is a flowchart of an example method for detecting and correcting drift in camera poses, in accordance with some implementations.

FIG. 17 is a flowchart of another example method for detecting and correcting drift in camera poses, in accordance with some implementations.

Like reference numerals refer to corresponding parts throughout the drawings.

### DESCRIPTION OF IMPLEMENTATIONS

Reference will now be made to various implementations, examples of which are illustrated in the accompanying drawings. In the following detailed description, numerous specific details are set forth in order to provide a thorough understanding of the invention and the described implementations. However, the invention may be practiced without these specific details or in alternate sequences or combinations. In other instances, well-known methods, procedures, components, and circuits have not been described in detail so as not to unnecessarily obscure aspects of the implementations.

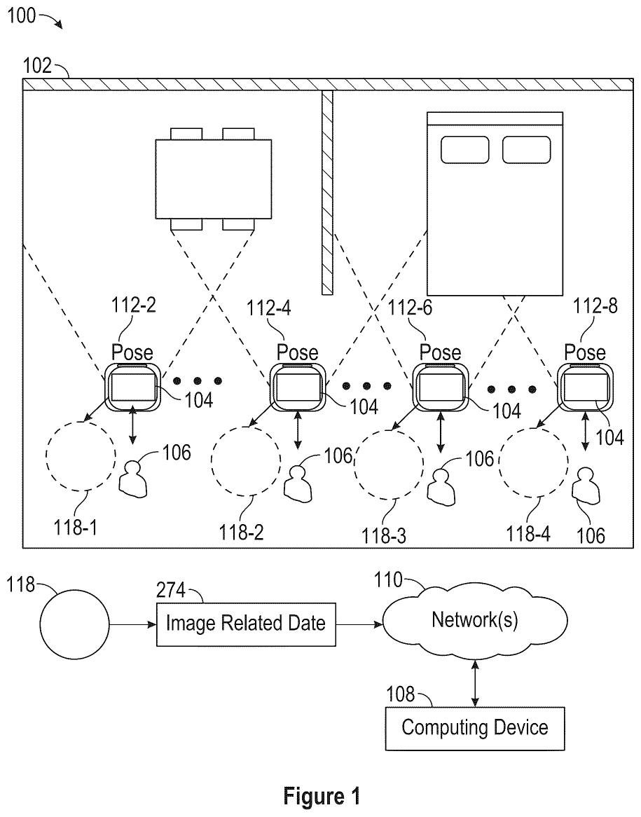

FIG. 1 is a block diagram of a computer system 100 for detecting and correcting drift in camera poses, in accordance with some implementations. In some implementations, the computer system 100 includes image capture devices 104, and a computing device 108.

An image capture device 104 communicates with the computing device 108 through one or more networks 110. The image capture device 104 provides image capture functionality (e.g., take photos) and communications with the computing device 108. In some implementations, the image capture device 104 is connected to an image preprocessing server system (not shown) that provides server-side functionality (e.g., preprocessing images, such as creating textures, storing environment maps (or world maps) and images and handling requests to transfer images) for any number of image capture devices 104.

In some implementations, the image capture device 104 is a computing device 108, such as desktops, laptops, smartphones, and other mobile devices, from which users 106 can capture images (e.g., take photos), discover, view, edit, or transfer images. In some implementations, the users 106 are robots or automation systems that are pre-programmed to capture images of the building structure 102 at various angles (e.g., by activating the image capture device 104). In some implementations, the image capture device 104 is a device capable of (or configured to) capture images and generate (or provide) world map data for scenes. In some implementations, the image capture device 104 is an augmented reality camera or a smartphone capable of performing the image capture and world map generation functions. In some implementations, the world map data includes (camera) pose data, tracking states, or environment data (e.g., illumination data, such as ambient lighting).

In some implementations, a user 106 walks inside a building structure 102 (e.g., a house), and takes pictures of rooms of the building structure 102 using the image capture device 104 (e.g., an iPhone) at different poses (e.g., poses 112-2, 112-4, 112-6, and 112-8). Each pose corresponds to a different perspective or view of a room of the building structure 102 and its surrounding environment, including one or more objects (e.g., a wall, furniture within the room) within the building structure 102. Each pose alone may be insufficient to reconstruct a complete 3-D model of the rooms of the building structure 102, but the data from the different poses can be collectively used to generate the 3-D model or portions thereof, according to some implementations. In some instances, the user 106 completes a loop inside and/or around the building structure 102. In some implementations, the loop provides validation of data collected around and/or within the building structure 102. In some implementations, data collected at a pose is used to validate data collected at an earlier pose. For example, data collected at the pose 112-8 is used to validate data collected at the pose 112-2.

At each pose, the image capture device 104 obtains (118) images of the building structure 102, and/or data for objects (sometimes called anchors) visible to the image capture device 104 at the respective pose. For example, the image capture device 104 captures data 118-1 at the pose 112-2, the image capture device 104 captures data 118-2 at the pose 112-4, and so on. As indicated by the dashed lines around the data 118, in some instances, the image capture device 104 fails to capture images or cameras have a drift (described below). For example, the user 106 switches the image capture device 104 from a landscape to a portrait mode, or receives a call. In such circumstances of system interruption, the image capture device 104 fails to capture valid data or fails to correlate data to a preceding or subsequent pose.

Although the description above refers to a single device 104 used to obtain (or generate) the data 118, any number of devices 104 may be used to generate the data 118. Similarly, any number of users 106 may operate the image capture device 104 to produce the data 118.

In some implementations, the data 118 is collectively a wide baseline image set, which is collected at sparse positions/orientations (or poses 112) inside the building structure 102. In other words, the data collected may not be a continuous video of the building structure 102 or its environment, but rather still images or related data with substantial rotation or translation between successive positions. In some implementations, the data 118 is a dense capture set, wherein the successive frames and poses 112 are taken at frequent intervals. Notably, in sparse data collection such as wide baseline differences, there are fewer features common among the images and deriving a reference pose is more difficult or not possible. Additionally, sparse collection also produces fewer corresponding real-world poses and filtering these, as described further below, to candidate poses may reject too many real-world poses such that scaling is not possible.

In some implementations, the computing device 108 obtains drift-related data 224 via the network 110. Based on the data received, the computing device 108 detects and/or corrects drifts in camera poses for the building structure 102. In some implementations, the computing device 108 applies a minimum bounding box to facades of the model, projects visual data of images associated with cameras in the camera solution that viewed the facades, photo-textures the projected visual data on each façade slice to generate a 3D visual representation of the building structure 102, and/or applies the photo-textured façade slice to the model (or assembles an aggregate of photo-textured façade slices according to the 3-D coordinate system of the model to generate a photo-textured 3-D model).

The computer system 100 shown in FIG. 1 includes both a client-side portion (e.g., the image capture devices 104) and a server-side portion (e.g., a module in the computing device 108). In some implementations, data preprocessing is implemented as a standalone application installed on the computing device 108 or the image capture device 104. In addition, the division of functionality between the client and server portions can vary in different implementations. For example, in some implementations, the image capture device 104 uses a thin-client module that provides only image search requests and output processing functions, and delegates all other data processing functionality to a backend server (e.g., the server system 108). In some implementations, the computing device 108 delegates image processing functions to the image capture device 104, or vice-versa.

The communication network(s) 110 can be any wired or wireless local area network (LAN) or wide area network (WAN), such as an intranet, an extranet, or the Internet. It is sufficient that the communication network 110 provides communication capability between the image capture devices 104, the computing device 108, or external servers (e.g., servers for image processing, not shown). Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol.

The computing device 108 or the image capture devices 104 are implemented on one or more standalone data processing apparatuses or a distributed network of computers. In some implementations, the computing device 108 and the image capture device 104 are a single device. In some implementations, the computing device 108 and the image capture device 104 support real-time drift detection and/or correction (e.g., during capture). In some implementations, the computing device 108 and the image capture device 104 support off-line drift detection and/or correction (e.g., post capture). In some implementations, the computing device 108 or the image capture devices 104 also employ various virtual devices or services of third party service providers (e.g., third-party cloud service providers) to provide the underlying computing resources or infrastructure resources.

In some implementations, the computer system 100 detects AR tracking drift using various methods. One method involves detecting changes in tracking session IDs, which can indicate a new world space initialization. Another method involves detecting changes in tracking session state. Another method involves analyzing the AR poses, or data associated therewith, for changes in translational and/or rotational accelerations, translational and/or rotational velocities, or long time delays between poses. These indicators suggest that the tracking may not be trusted for those poses.

In some implementations, after drift is detected and locally rigid pose groups are identified, the computer system 100 can use a set of images within each group for feature matching (e.g., classical feature matching) and triangulation to stitch the groups together. This approach may avoid the need for exhaustive pairwise feature matching across all images.

In some implementations, during the bundle adjustment step, the computer system 100 can use the identified pose groups to provide better pose priors. By distinguishing between poses from the same rigid group and those of different groups, the computer system 100 can feed only the reliable relative priors into the bundle adjustment process, for example from the same group or from neighboring groups, leading to improved pose estimates.

In some implementations, the computer system 100 can also reconstruct point clouds separately for each group and provide tools for a modeler to manually adjust these point clouds if necessary. This serves as a backup method when automated approaches are insufficient.

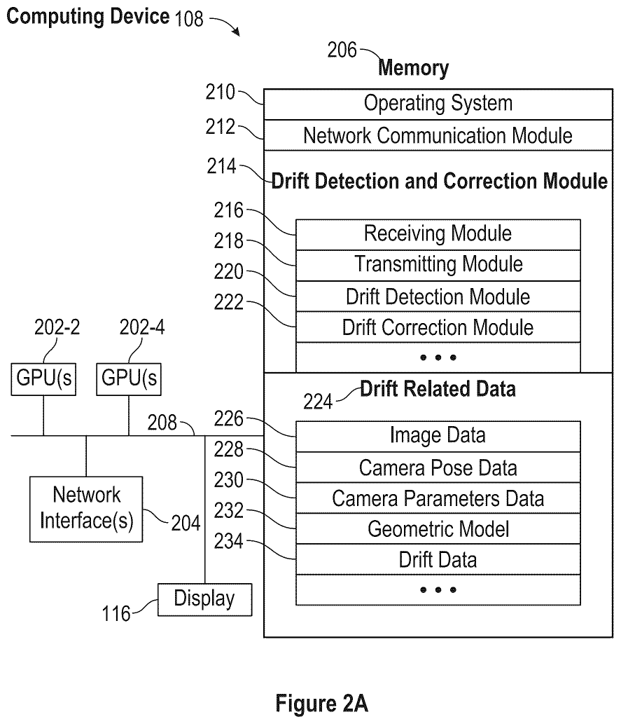

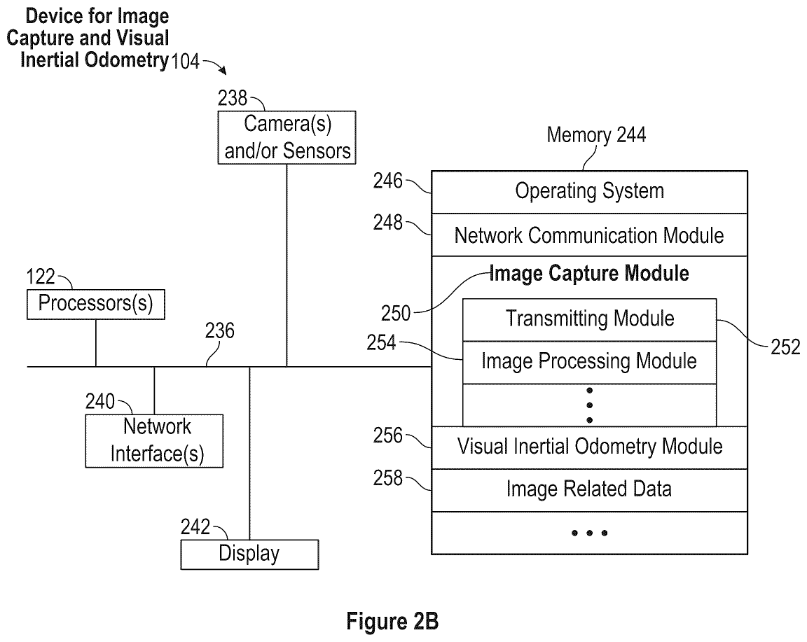

FIG. 2A is a block diagram illustrating the computing device 108 in accordance with some implementations. In some implementations, the computing device 108 is a server system that includes one or more processing units (e.g., CPUs 202-2 or GPUs 202-4), one or more network interfaces 204, one or more memory units 206, and one or more communication buses 208 for interconnecting these components (e.g., a chipset).

The memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 206, optionally, includes one or more storage devices remotely located from one or more processing units 202. The memory 206, or alternatively the non-volatile memory within the memory 206, includes a non-transitory computer readable storage medium. In some implementations, the memory 206, or the non-transitory computer readable storage medium of the memory 206, stores the following programs, modules, and data structures, or a subset or superset thereof:
operating system 210 including procedures for handling various basic system services and for performing hardware dependent tasks;
network communication module 212 for connecting the computing device 108 to other computing devices (e.g., image capture devices 104, or image-related data sources) connected to one or more networks 110 via one or more network interfaces 204 (wired or wireless);
drift detection and correction module 214 for detecting and correcting drifts, which includes, but is not limited to:
   a receiving module 216 for receiving, or obtaining, information related to images and/or drifts. For example, the module 216 handles receiving a model 230 of a building that includes a camera solution and a plurality of images (e.g., image data 226) from the image capture devices 104 associated with camera poses within the camera solution, or image-related data sources. In some implementations, the model 230 includes structured geometry (e.g., geometric model). In some implementations, the model 230 includes unstructured geometry (e.g., point or line cloud). In some implementations, the receiving module also receives camera pose data 228. In some implementations, the receiving module also receives processed images from the GPUs 202-4 for rendering on the display 116;
   a transmitting module 218 for transmitting image-related information. For example, the module 218 handles transmission of image-related information to the GPUs 202-4, the display 116, or the image capture devices 104;
   a drift detection module 220 for detecting inconsistencies associated with camera poses (e.g., drifts in the camera poses). Details of the drift detection module 220 are described herein, for example below in reference to FIGS. 1-17, according to some implementations; and
   a drift correction module 222 for correcting drifts detected by the drift detection module 220. Details of the drift correction module 222 are described herein, for example below in reference to FIGS. 1-17, according to some implementations;
one or more server database of drift related data 224 storing data for drift detection and correction, including but not limited to:
   image data 226 that stores image data received by the receiving module 214;
   camera pose data 228 that stores camera pose data received or derived by the receiving module 216;
   geometric model 230 that stores geometric models received by the receiving module 216;
   camera parameters data 232 received or derived by the receiving module 216 and/or generated by the drift correction module 222; and
   drift data 234 that stores data generated by the drift detection module 220 and/or the drift correction module 222.

The above description of the modules is only used for illustrating the various functionalities. In particular, one or more of the modules may be combined in larger modules to provide similar functionalities.

In some implementations, an image database management module (not shown) manages multiple image repositories, providing methods to access and modify image-related data that can be stored in local folders, NAS or cloud-based storage systems. In some implementations, the image database management module can even search online/offline repositories. In some implementations, offline requests are handled asynchronously, with large delays or hours or even days if the remote machine is not enabled. In some implementations, an image catalog module (not shown) manages permissions and secure access for a wide range of databases.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

Although not shown, in some implementations, the computing device 108 further includes one or more I/O interfaces that facilitate the processing of input and output associated with the image capture devices 104 or external server systems (not shown). One or more processors 202 obtain images and information related to images from image data 226, camera pose data 228, and/or geometric model 230 (e.g., in response to a request to detect and/or correct drifts for a building), processes the images and related information, detects and/or corrects drifts. I/O interfaces facilitate communication with one or more image-related data sources (not shown, e.g., image repositories, social services, or other cloud image repositories). In some implementations, the computing device 108 connects to image-related data sources through I/O interfaces to obtain information, such as images stored on the image-related data sources.

FIG. 2B is a block diagram illustrating a representative image capture and visual inertial odometry device 104 that is capable of capturing images (or taking photos) of building structures 102 (e.g., a house) and performing visual inertial odometry from which image related data 258 is extracted, in accordance with some implementations. The image capture device 104, typically, includes one or more processing units (e.g., CPUs or GPUs) 122, one or more network interfaces 240, memory 244, optionally display 242, optionally one or more cameras and/or sensors 238 (e.g., IMUs), and one or more communication buses 236 for interconnecting these components (sometimes called a chipset).

Memory 244 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 244, optionally, includes one or more storage devices remotely located from one or more processing units 122. Memory 244, or alternatively the non-volatile memory within memory 244, includes a non-transitory computer readable storage medium. In some implementations, memory 244, or the non-transitory computer readable storage medium of memory 244, stores the following programs, modules, and data structures, or a subset or superset thereof:
an operating system 246 including procedures for handling various basic system services and for performing hardware dependent tasks;
a network communication module 248 for connecting the image capture and visual inertial odometry device 104 to other computing devices (e.g., the computing device 108 or image-related data sources) connected to one or more networks 110 via one or more network interfaces 240 (wired or wireless);
an image capture module 250 for capturing (or obtaining) images captured by the image capture device 104, including, but not limited to:
   a transmitting module 252 to transmit image-related information (similar to the transmitting module 218); and
   an image processing module 254 to post-process images captured by the image capture and visual inertial odometry device 104. In some implementations, the image capture module 250 controls a user interface on the display 242 to confirm (to the user 106) whether the captured images by the user satisfy threshold parameters for drift detection, drift correction, and/or generating 3-D representations. For example, the user interface displays a message for the user to move to a different location so as to capture two sides (or two rooms) of a building, or so that all sides (or all rooms) of a building are captured;
optionally, a visual inertial odometry module 272 that generates visual inertial odometry data (e.g., tracking session ID, tracking session state, pose, acceleration, and/or velocity of the image capture device 104 by using the image related data 258 and one or more Inertial Measurement Units (IMUs)). In some implementations, the visual inertial odometry module 272 includes functionality to detect discontinuities or inconsistencies (e.g., drifts) in the sequence of camera poses. This can involve detecting changes in tracking session ID changes, detecting changes in tracking session state, detecting changes in translational and/or rotational acceleration exceeding expected/realistic thresholds, detecting changes in translational and/or rotational velocities exceeding expected/realistic thresholds, detecting temporal delays between poses exceeding expected/realistic thresholds, and the like; and/or
a database of image-related data 274 storing data for drift detection and/or correction.

Examples of the image capture and visual inertial odometry device 104 include, but are not limited to, a handheld computer, a wearable computing device, a personal digital assistant (PDA), a tablet computer, a laptop computer, a cellular telephone, a smartphone, an enhanced general packet radio service (EGPRS) mobile phone, a media player, a navigation device, a portable gaming device console, a tablet computer, a laptop computer, a desktop computer, or a combination of any two or more of these data processing devices or other data processing devices. In some implementations, the image capture and visual inertial odometry device 104 is an augmented-reality (AR)-enabled device that captures augmented reality maps (AR maps, sometimes called world maps). Examples include Android devices with ARCore, or iPhones with ARKit modules.

In some implementations, the image capture device 104 includes (e.g., is coupled to) a display 242 and one or more input devices (e.g., camera(s) or sensors 238). In some implementations, the image capture device 104 receives inputs (e.g., images) from the one or more input devices and outputs data corresponding to the inputs to the display for display to the user 106. The user 106 uses the image capture device 104 to transmit information (e.g., images) to the computing device 108. In some implementations, the computing device 108 receives the information, processes the information, and sends processed information to the display 116 or the display of the image capture device 104 for display to the user 106.

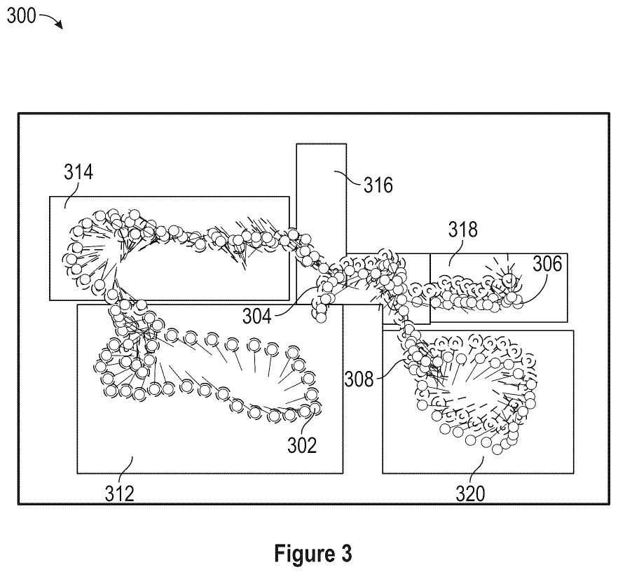

FIG. 3 is a schematic diagram of example drifts for camera poses 300, according to some implementations. If camera poses are input from a VIO system, such as ARKit/ARCore, then the camera poses may have good relative poses. But over time, the camera poses may suffer from drift. This is illustrated in FIG. 3 where the dots indicate image locations. The rectangles 312, 314, 316, 318, and 320 may each represent rooms in a house. The capture path (shown in darker grey) corresponds to a path a user walks and a corresponding device takes. The data captured by the device is shown in lighter grey. Initially, the data that is captured by the device overlaps (e.g., at image location 302) with the path the device takes. Subsequently, the data that is captured by the device drifts relative to the path the device takes. The drift occurs because inertial sensors are good for pose estimation in the short term but tend to drift over time in the absence of global pose measurements or constraints. In FIG. 3, raw camera poses drift towards the end of the user trajectory as compared to the modeling poses. For example, camera pose aligns with modeling pose at image location 304, but drifts at image location 306. Similarly, initially camera pose and modeling pose align at image location 308, but there is a drift at image location 310.

### Grouping for Correcting Drift

Some implementations perform grouping to correct camera pose drift. Given a set of posed images, some implementations divide camera poses into smaller sets based on their temporal ordering. Camera poses within a same group have a unique group offset transform for defining where the group should be placed in world space.

Example grouping logics are described herein. The number of groups can vary from one to the number of camera poses. If there is just one group, visual alignment can be difficult for a large number of camera poses in case there is significant drift towards the end of capture. If there are as many groups as camera poses, this may result in discarding any relative transformation between neighboring camera poses and trying to independently solve each of their extrinsic parameters.

During the drift correction process, some implementations use image markups to estimate the offset parameters for each group. Some implementations use as few groups as possible to reduce the number of image markups needed, and possibly reduce the computation, storage, and time needed. Some implementations look for acceptable alignment between model elements (e.g., geometry, points, lines) and image elements (e.g., points, lines). In some implementations, the drift correction process is independent of the modeling process.

### Iterative Modeling and Drift Detection

In some implementations, modeling and camera pose correction are performed concurrently. For example, a user may first solve different parts of the geometry depending on an initial alignment of camera poses (e.g., AR camera poses). After this, the user may continue to augment the geometry, for example by growing the existing geometry or adding new geometry. If at any point a number of images associated with camera poses are not aligning well with the geometry, then that may be an indicator of camera pose drift.

When a drift is detected, some implementations start creating a new camera pose group from that point onwards. To correct for camera pose drift, users and/or the system draw markups to indicate correspondence between the model elements, such as geometry, points, and lines and their image space representation.

In some implementations, once drift has been corrected for a camera pose, the drift is propagated to camera poses that are temporally subsequent to that camera pose. In some implementations, this process is repeated until all parts of the environment subject to the capture have been modeled and there is acceptable alignment between the model elements and the image elements. The propagation step applies the same correction to all camera poses within the same group. This is because relative camera poses between nearby frames are quite accurate. Suppose there is a group with three camera poses 6, 7 and 8 represented by rotation and translation matrices pairs [R6, T6], [R7, T7], and [R8, T8], respectively, and suppose the group offset is estimated as [R_off, T_off] for the group. Propagation here refers to applying the same offset to all camera poses within the group: [R6, T6]×[R_off, T_off], [R7, T7]×[R_off, T_off], [R8, T8]×[R_off, T_off]. In some embodiments, the offset includes a rotation and a translation, an example of which is described above. In some embodiments, the offset includes only translation. In some embodiments, the offset includes only rotation. If a drift has been corrected using only a few camera poses and if the offset propagation looks good (e.g., by visual alignment check) on other images, then a user who is using a modeling software, and working with the images to create a model, can use the corrected and solved camera poses for modeling.

### Example Grouping Methods

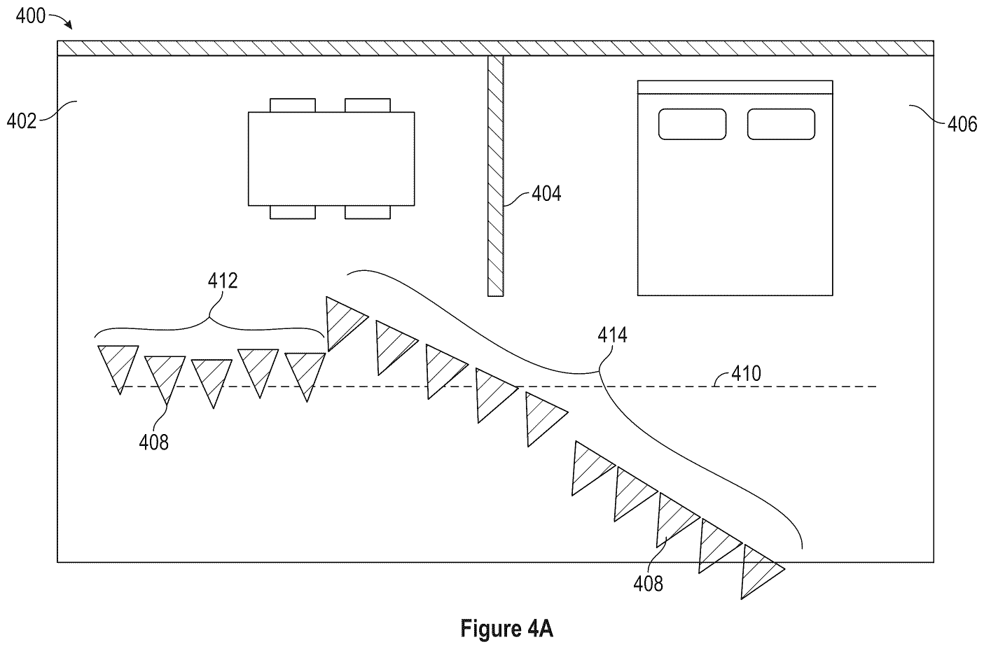

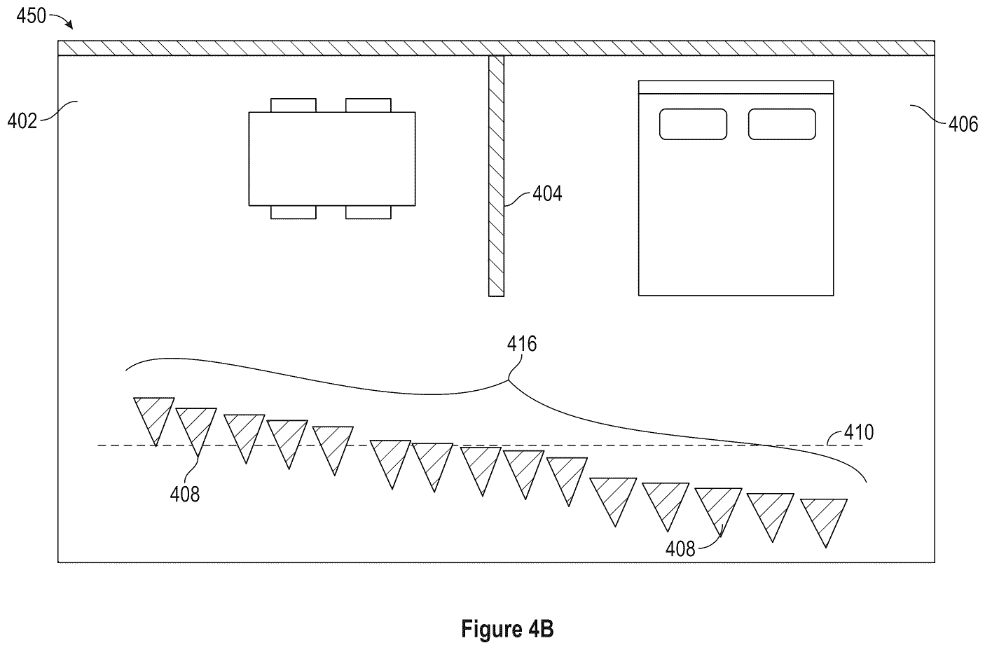

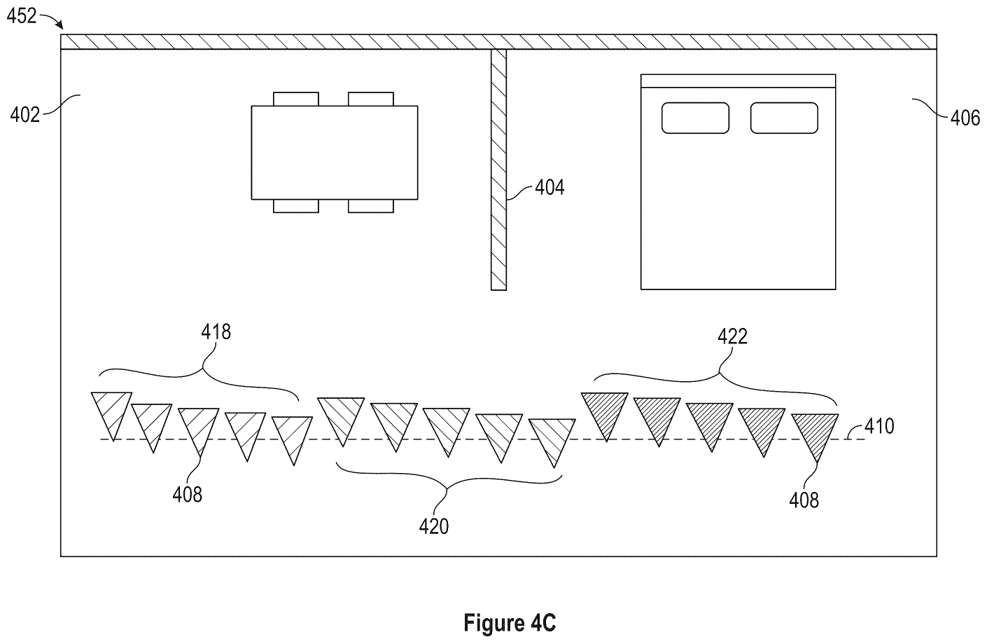

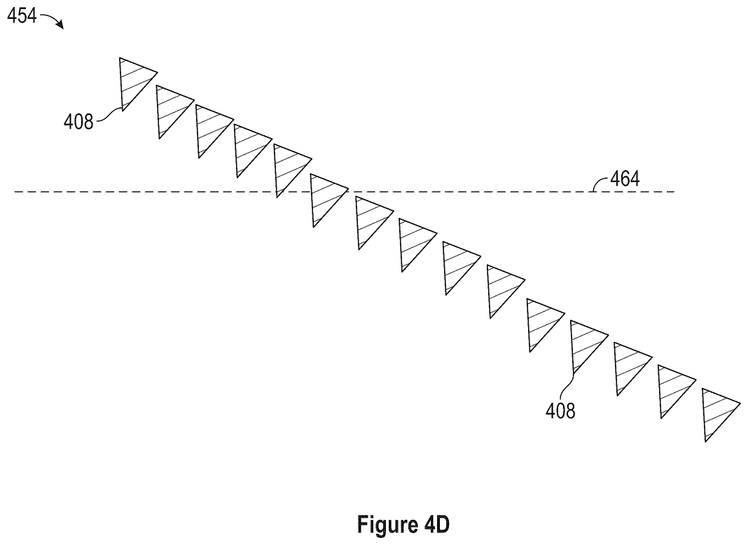

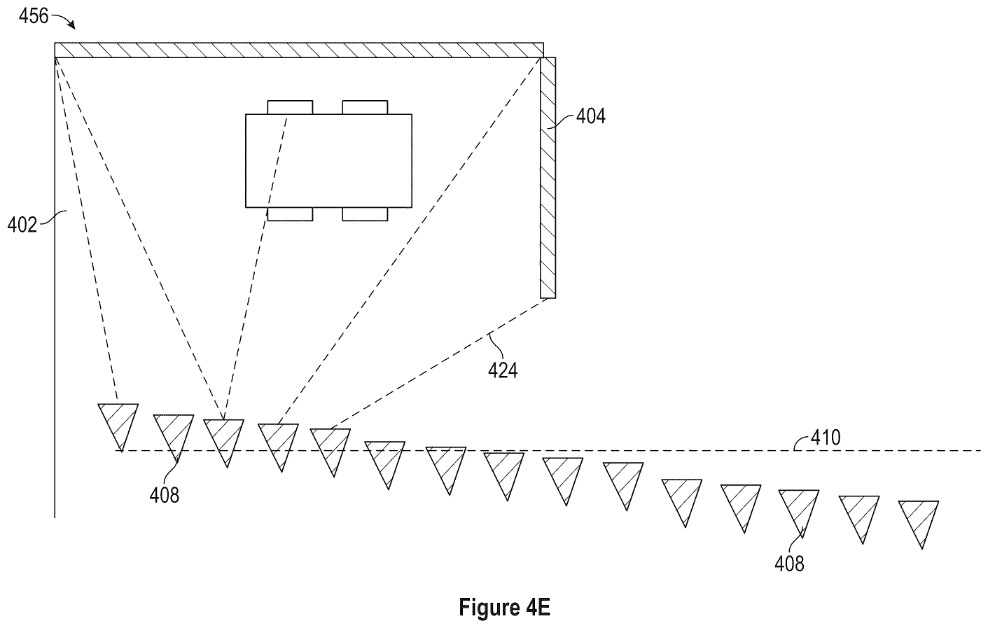

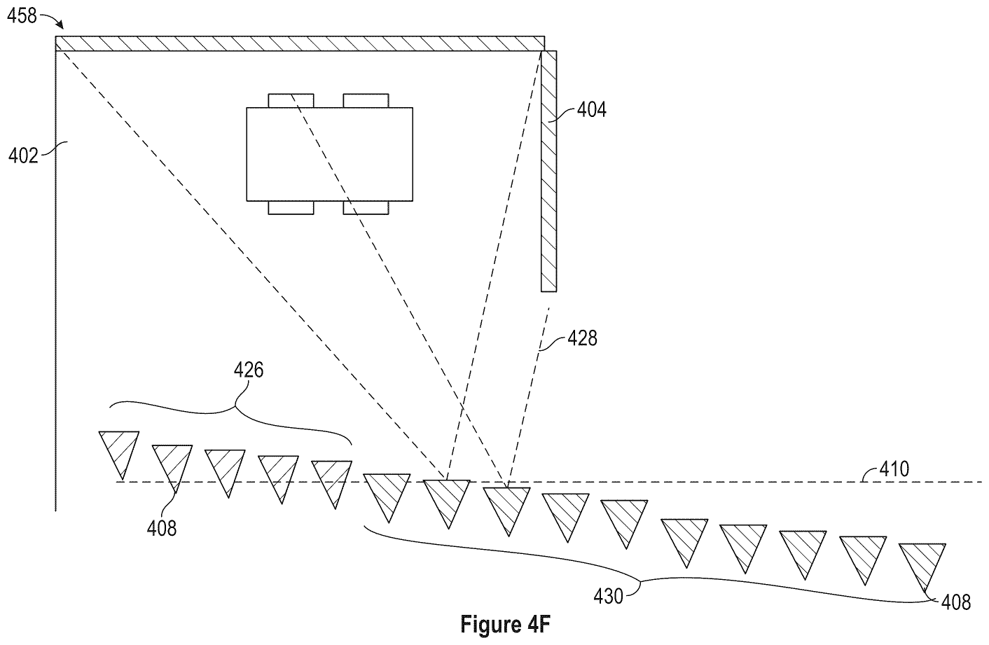

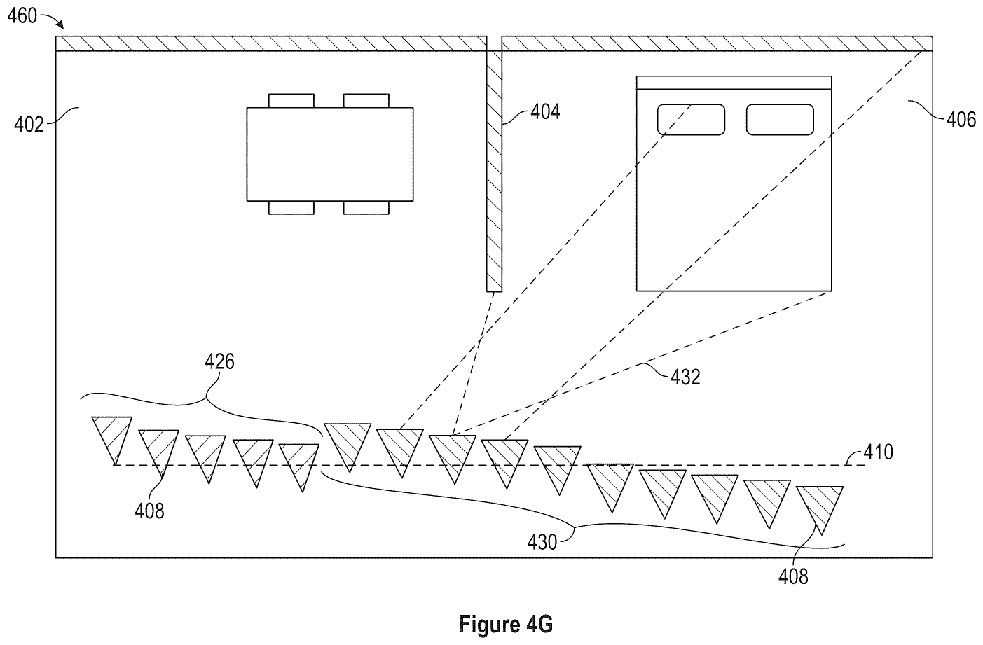

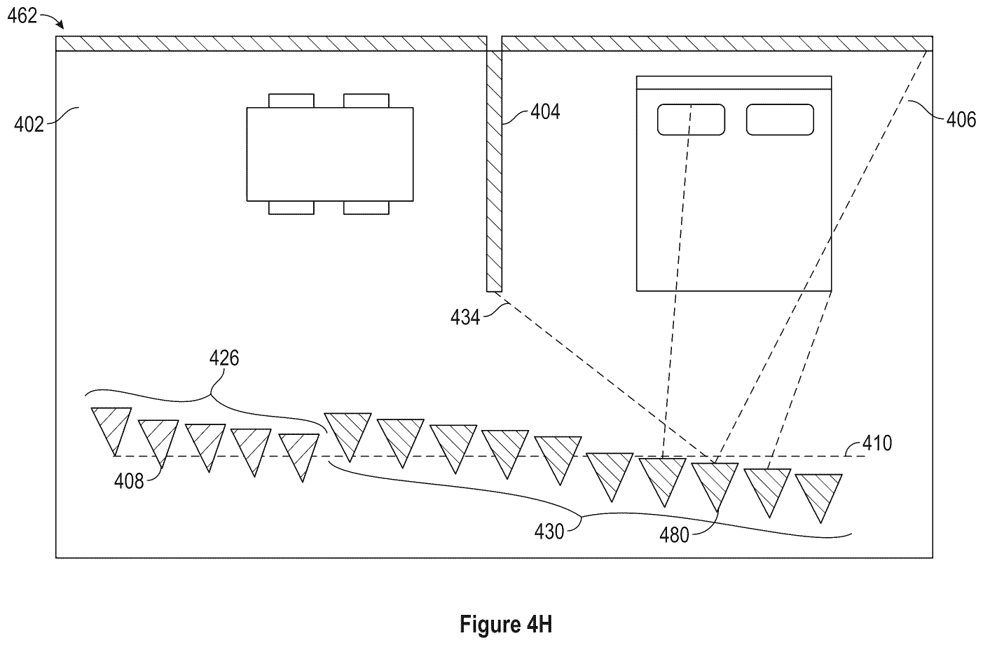

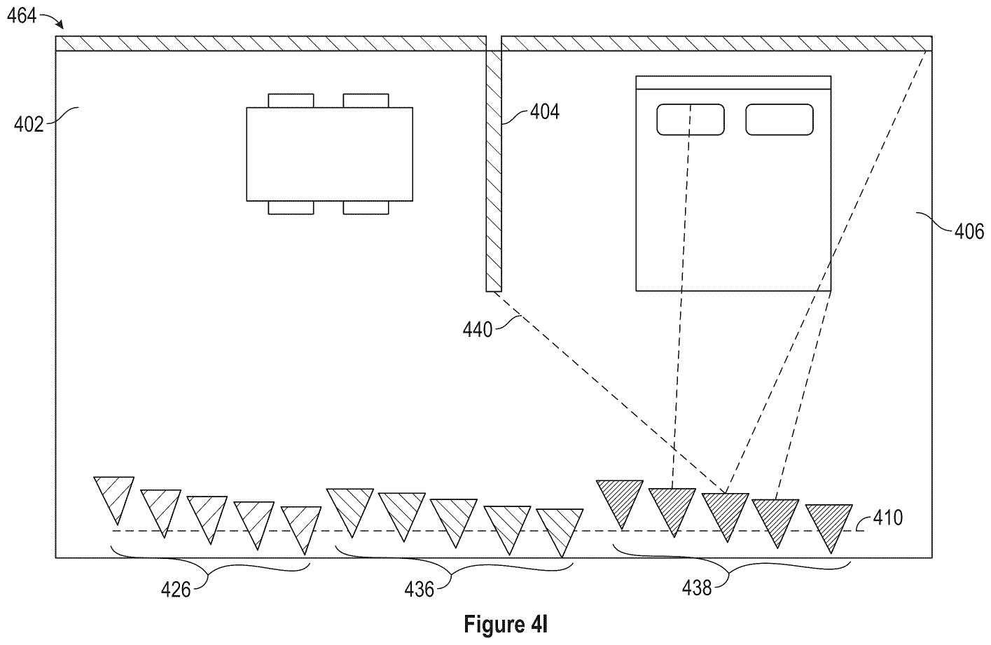

FIG. 4A is a schematic diagram of example camera poses with drastic drift errors 400, according to some implementations. Camera poses for Visual Inertial Odometry (VIO) methods, such as ARKit or ARCore camera poses are prone to drift errors. This may happen as a slow drift in camera poses over time and length of the user trajectory. It may be a sudden large jump induced if a VIO system resets or from other inconsistencies (e.g., tracking session ID, tracking session state, acceleration, velocity, time between subsequent poses, etc.). FIG. 4A shows a drastic drift 400 in camera poses, according to some implementations. A building may have several rooms or enclosures. In this example, the building has two rooms 402 and 406, separated by a wall 404. A user (e.g., the user 106) or users may walk inside the building and capture, or take, images, or pictures (or record a video). Actual path is shown as a red dashed line 410 and camera position is shown as blue triangles 408. Camera poses 412 do not show a drift, whereas camera poses 414 have a drastic drift.

FIG. 4B is a schematic diagram of example camera poses with gradual drift errors 450, according to some implementations. In contrast to FIG. 4A, the camera poses 416 show a gradual drift (from the line 410).

FIG. 4C is a schematic diagram of example camera poses after drift correction 452, according to some implementations. In some implementations, the process for correcting drift includes modeling, drift detection, and drift correction in an iterative way until all images are aligned with the model. Some implementations group camera poses (e.g., poses 418, poses 420, and poses 422) as a way of keeping camera poses with low relative drift together. This allows camera poses within the same group retain their relative poses and only change their global position (e.g., in relation to the line 410) and rotation and/or translation in a collective manner. The example shows the actual path 410 versus camera poses corrected in discrete steps for each group.

FIG. 4D is a schematic diagram of example initial camera poses 454 for drift detection and correction, according to some implementations. The initial camera poses (e.g., poses 408) and later camera poses may be in different coordinate systems. For example, ARKit of ARCore world coordinate system (e.g., line 464) may be chosen randomly depending on a first image associated with a first camera pose of the poses 408. Hence, some implementations use the initialization process to orient the camera poses to the Manhattan modeling system. After this step, the same Manhattan offset can also be propagated to other camera poses and the system can model a portion of the building (e.g., a room) using this information.

FIG. 4E is a schematic diagram of example initialization and modeling 456 for drift detection and correction, according to some implementations. After initialization (as described above in reference to FIG. 4D), some implementations start modeling the geometry. The images 424 associated with the poses 408 can be used for the modeling.

FIG. 4F is a schematic diagram of example drift detection and correction 458, according to some implementations. For drift detection, beyond a certain point, the drift in camera poses may be significant such that the model elements may not be aligned with the images elements. For example, in FIG. 4F, the drift after poses 426 may be significant (for poses 430) such that the model elements are not aligned with the image elements (e.g., image elements of images 428). If model generation has used multiple prior images associated with multiple prior camera poses with sufficient baseline between them, then there is a high confidence that the modeling is correct and it is the camera poses which have error. Confidence in the model can increase with more modeling and/or other quantitative metrics, such as covariance of model parameters. Once drift has been detected, some implementations align the model elements and the image elements of the image associated with the drifted camera pose, for example by reprojecting the model into the image associated with the drifted camera pose and adjusting one or more camera parameters of the drifted camera pose until the model elements of the model and the image elements of the image associated with the drifted pose align (e.g., have no or low reprojection error). This can be done by adding markup correspondences such as 3D to 2D point markups or 3D to 2D line markups. Some implementations optimize offset of an entire group of camera poses so as to minimize the alignment error between model elements and image elements of images associated with the group of camera poses.

FIG. 4G is a schematic diagram of example modeling 460 parts of a model using corrected camera poses, according to some implementations. Once drift has been corrected, some implementations propagate the correction to all subsequent camera poses and the remainder camera poses can be used for modeling new parts of the environment. Some implementations continue generating other parts of the model using corrected camera poses. For example in FIG. 4G, the corrections in FIG. 4F (sometimes referred to as corrected camera poses) are used when processing the poses 430, for generating the model elements of the environment that correspond to the wall 404 and the room 406, based on the images 432.

FIG. 4H is a schematic diagram of example iterative drift detection and correction 462, according to some implementations. In some implementations, modeling, drift identification and correction, are repeated iteratively. Some implementations continue generating model elements until alignment between the model elements and image elements of images associated with poses is bad (e.g., reproduction error is greater than 30 pixels). For example, a second part of the poses 430 in FIG. 4H start to drift, when modeling using the images 434.

FIG. 4I is a schematic diagram of example iterative drift detection and correction 464, according to some implementations. In some implementations, when alignment is bad, the system corrects for camera poses (e.g., by creating a new group of camera poses) and continues the modeling process iteratively. For example, in FIG. 4I, because the second part of the poses 430 of FIG. 4H showed misalignment, the system splits the poses 430 of FIG. 4H into two sets 436 and 438, and corrects for camera poses in the group 438 and continues the modeling.

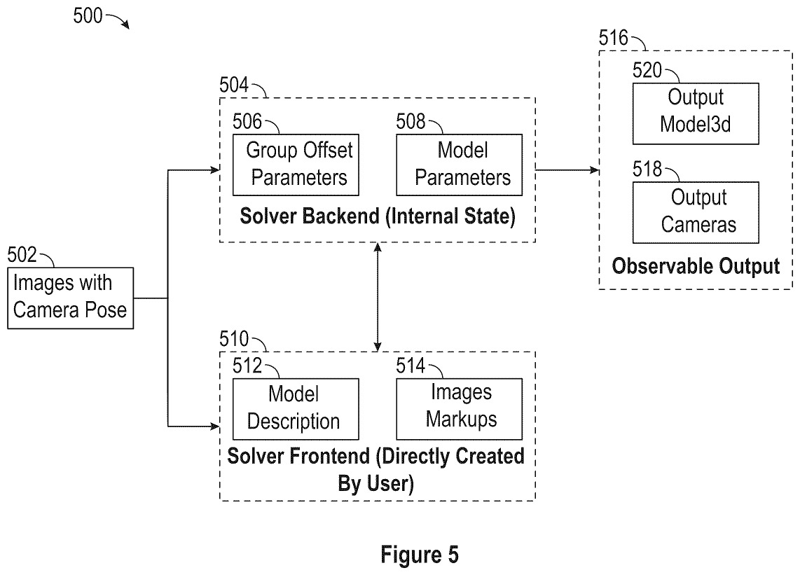

FIG. 5 is a block diagram of an example system 500 for modeling, drift detection, and drift correction, according to some implementations. Images and associated camera poses 502 (e.g., the poses 408) is a list of images with image containing (i) camera parameters (pinhole model) that include KAR, RAR, and TAR (world to camera), (ii) image file with RGB images (each image having a width w and a height h), and (iii) camera poses. In some embodiments, a model description 512 may be generated based on user inputs from a user using a user interface (UI), for a camera solver frontend 510. In some embodiments, the model description 512 may be generated without user inputs. The model description may include a model of an environment. The model may be a geometric model, a point cloud, a line cloud, or a combination thereof. The model may describe corners, walls, and openings, in the environment, corners connected to each other as part of a wall, points having Manhattan constraints, and an initial estimate of the corner locations (e.g., estimates added via the UI). In some embodiments, image markups 514 may be generated based on user inputs from a user. In some embodiments, image markups 514 may be generated without user inputs. The image markups 514 may include 3D-2D point correspondence, 3D-2D line correspondence, or a combination thereof. Internal state 504 of the camera solver includes model parameters 508 that in turn includes a set of parameters. These parameters include a point cloud of N points that can be represented by a lesser number of parameters if there are constraints between the points. The minimal set of points are stored in this vector. Manhattan constraints define which points are connected to each other. The model parameters 508 also includes a list of lines where each line is simply a pair of point identifiers. Internal state 504 of the camera solver also includes group offsets 506. Each camera pose belongs to a group. In some embodiments, each group has a rotation offset, translation offset, or a combination thereof. By default, the entire system has a single group but more than one may be needed in order to correct for drift. Output 516 includes (i) corrected camera parameters 518 (pinhole model): KF, RF, TF (world to camera), and (ii) a model 520. In some embodiments, the model 520 includes geometries, a point cloud, a line cloud, or a combination thereof, with each geometry, point, line, or combination thereof, uniquely identified by an identifier and a list of geometries, points, lines, or combinations thereof, which are connected to each other as edges. In some embodiments, the list is the same as the input provided in the solver user interface.

### System Parameterization and Optimization

For the camera, final camera intrinsics remain the same as augmented reality (AR) intrinsics. Final camera extrinsics are created by applying a group offset to the initial AR extrinsics:

$$\begin{matrix}{K}_{F} = {K}_{AR} \\ [ \begin{matrix}{R}_{i , F} & {T}_{i , F} \\ 0 & 1\end{matrix} ] = {[ \begin{matrix}{R}_{i , AR} & {T}_{i , AR} \\ 0 & 1\end{matrix} ] [ \begin{matrix}{R}_{j , OFF} & {T}_{j , OFF} \\ 0 & 1\end{matrix} ]}^{- 1}\end{matrix}$$

In the equation above, i denotes the i-th camera going from [1, total number of camera poses], and j denotes the group identifier [0, number of groups−1].

For group offset, a group represents a set of camera poses which have the same rotation and translation offset to convert them from capture space to modeling space. It is assumed that camera poses within the same group have good relative accuracy.

$$[ \begin{matrix}{R}_{i , F} & {T}_{j , F} \\ 0 & 1\end{matrix} ]$$

Each group is represented by size degrees of freedom (DOFs) for rotation and translation offset. A camera pose trajectory may have one or more groups associated with it. The purpose of grouping is to break the camera pose trajectory into smaller blocks such that each block is well aligned with respect to the global coordinate axes.

For a parametric floorplan, model elements of a model include walls, which is a collection of points, lines, or combinations thereof. Each point, line, or combination thereof is a function of the unique identifier with the point, line, or combination thereof, and parameters defining the model elements. For simplicity, suppose the points in the model are linked to each other with Manhattan constraints. A Manhattan constraint can be of the following types:
Same Manhattan axis: for example, if camera poses p1 and p2 are along the X axis then their Y and Z coordinates are the same and only the X coordinate varies.
Same Manhattan plane: for example, if camera poses p1 and p2 are along the Manhattan XZ plane then they have the same Y coordinate but x and z may be different.

With the Manhattan constraints, the function can be simplified as follows:

$${X}_{id} = f ( id , \overline{p} ) = [ \begin{matrix}{p}_{id , x} \\ {p}_{id , y} \\ {p}_{id , z}\end{matrix} ]$$

In the equation above, p̅ is the minimal set of parameters which define a shape.

Image markup evidence denotes the information which relates the 3D model elements in the model space (e.g., 3D space) to a 2D image elements in the image space (e.g., 2D space). Evidence can be either a 3D to 2D point correspondence or a 3D to 2D line correspondence. 3D to 2D point correspondence can include an identifier of the 3D point of the model element, and a 2D key point in the image indicating where the particular 3D point should lie. 3D to 2D line correspondence can include an identifier of the first 3D point on the line segment, an identifier of the second 3D point on the line segment, a 2D key point defining an end point of the 2D line segment, and a 2D key point defining the other end point of the 2D line segment. For a 3D to 2D line correspondence, the end points in 2D space may be different from the end points in 3D space.

### Example Optimizations

Some implementations perform simultaneous (or concurrent) modeling and drift correction. The solver backend optimizes for the internal state whenever called. Some implementations use a gradient descent solver (e.g., solver in Ceres) for optimizing over the point and line reprojection error of different markups.

Some implementations perform drift correction only. If there is sufficient confidence in the model, some implementations keep the model parameters constant in the optimization step and only optimize for the camera pose drift. This is useful for the case where there is a need to align camera poses as best as possible to existing geometry.

### Example Methods for Drift Detection and Correction

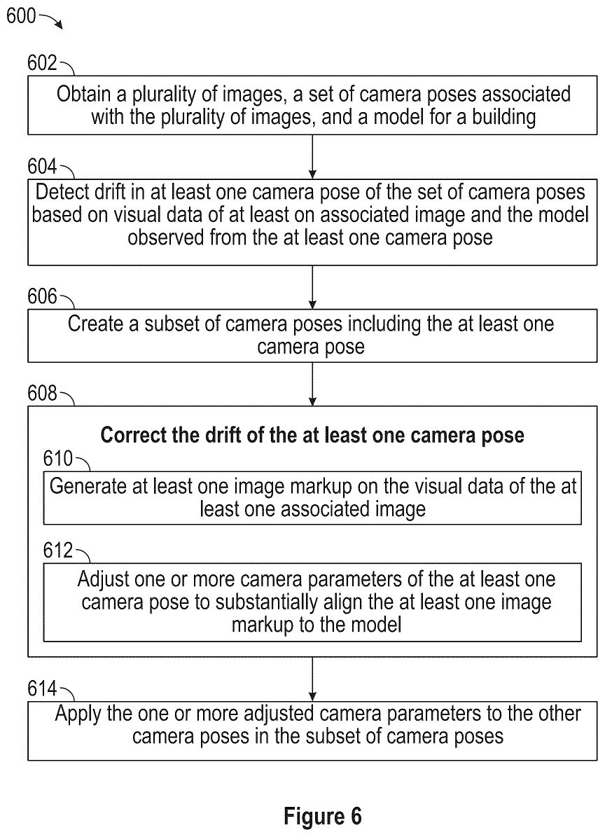

FIG. 6 is a flowchart of an example method 600 for detecting and correcting drift in camera poses, in accordance with some implementations. The method 600 is performed in a computing device (e.g., the device 108 and one or more modules of the drift detection and correction modules 214).

The method includes obtaining (602) a plurality of images, a set of camera poses and a model for a building. In some implementations, the model includes structured geometry (e.g., a geometric model). In some implementations, the model includes unstructured geometry (e.g., point or line cloud). In some implementations, the model includes a number of corners, walls, and openings, a number of corners connected to each other as part of a wall, points having Manhattan constraints, and an initial estimate of corner locations. In some implementations, the model is a 3D floor plan of a room obtained via a camera and a LIDAR scanner, and the camera is used to obtain the plurality of images. Examples of camera poses and receiving camera poses are described above in reference to FIG. 1, according to some implementations.

The method also includes detecting (604) inconsistencies associated with at least one camera pose of the set of camera poses (sometimes referred to as detecting drifts in the camera poses) based on visual data of at least one associated image and the model observed from the at least one camera pose. In some implementations, detecting inconsistencies associated with the at least one camera pose includes detecting a projection difference of more than 30 pixels between the visual data of the at least one associated image and the model observed from the at least one camera pose. In some implementations, detecting inconsistencies is based on temporal ordering of the camera poses. In some implementations, detecting inconsistencies and modeling are performed in an iterative manner. In some implementations, the method further includes modeling (or generating new portions of the model). In some implementations, the model observed from the at least one camera pose is obtained by reprojecting the obtained model in a frustum of the at least one camera pose according to a transform between earlier camera poses and the at least one camera pose. In some implementations, the model is generated according to images earlier in a capture session for obtaining the plurality of images.

In some implementations, detecting inconsistencies associated with the at least one camera pose includes detecting a change in tracking session identification associated with the plurality of captured camera poses. In some implementations, detecting inconsistencies associated with the at least one camera pose includes detecting a change in tracking session state associated with the plurality of captured camera poses. In some implementations, detecting inconsistencies associated with the at least one camera pose includes detecting a translational acceleration exceeding a translational acceleration threshold. In some implementations, the translational acceleration threshold is five meters per second squared. In some implementations, detecting inconsistencies associated with the at least one camera pose includes detecting a rotational acceleration exceeding a rotational acceleration threshold. In some implementations, the rotational acceleration threshold is ten radians per second squared. In some implementations, detecting inconsistencies associated with the at least one camera pose includes detecting a translational velocity exceeding a translational velocity threshold. In some implementations, the translation velocity threshold is two meters per second. In some implementations, detecting inconsistencies associated with the at least one camera pose includes detecting a rotational velocity exceeding a rotational velocity threshold. In some implementations, the rotational velocity threshold is three radians per second.

The method also includes creating (606) a subset of camera poses including the at least one camera pose. In some implementations, camera poses within the subset have a unique group offset transform for defining where the subset should be placed in a world space. In some implementations, a maximum number of created subsets is a number of camera poses in the set of camera poses. In some implementations, creating the subset of camera poses is performed when a user (e.g., a modeler) recognizes that geometry does not align. In some implementations, when reprojection error is around 10-30 pixels (depending on resolution of the image) then drift can be assumed and that triggers the creation of a new group. Some implementations take the position of a modeled feature and detect a distance between the feature and the actual position in the image. Some implementations perform a Harris corner detection to determine where there are corners in an image, then compare that to where the corners of the generated geometry appears and determine a reprojection error between the two. A particular room may have a number of groups based on interferences with tracking that may exacerbate drift. Rooms with tight geometries that require a user to move the camera to capture the space can result in more drift and therefore more groups produced from this process.

The method also includes correcting (608) the inconsistencies associated with the at least one camera pose by generating (610) at least one image markup on the visual data of the at least one associated image, and adjusting (612) one or more camera parameters of the at least one camera pose to substantially align the at least one image markup to the model. In some implementations, adjusting the one or more camera parameters includes constraining at least one degree of freedom of the at least one camera pose and adjusting camera parameters other than the at least one degree of freedom. In some implementations, generating at least one image markup further includes corresponding the at least one image markup with 3D elements of the model. In some implementations, where the model comprises a geometric model, the 3D elements are 3D geometric elements. In some implementations, where the model comprises a point cloud, the 3D elements are 3D points. In some implementations, where the model comprises a line cloud, the 3D elements are 3D lines. In some implementations, instead of perfect alignment with the geometry, the alignment accounts for global coordinate system or Manhattan alignment. In some implementations, the image markups are obtained as user input via a user interface. In some implementations, the at least one image markup is generated by applying line detection and/or Harris corner detection, on the visual data of the at least one camera pose. Constraining the z-axis does not by itself align an image. It is by adjusting the other parameters that the visual data and geometric model are aligned. In practice, the rotation degree of freedom about the z-axis is fixed and then a transform applied to the camera pose that aligns the markups to the geometry of the model, not unlike a bundle adjustment. Parameters refer to the other degrees of freedom (i.e., rotation or translation about y- and x-axes) or focal length. Constraining the z-axis minimizes the variables in the transform calculation, which makes the adjustment of the other parameters casier to calculate but should also have the effect of maintaining some semblance of the original camera pose and not inducing too drastic a correction.

The method also includes applying (614) the one or more adjusted camera parameters to the other camera poses in the subset of camera poses. In some implementations, only the at least one camera pose has its parameters adjusted, and then the resultant transform is applied to subsequent camera poses.

In some implementations, the method further includes generating new parts of the model based on one or more camera poses of the subset of camera poses.

In some implementations, the set of camera poses are obtained from a visual inertial odometry system.

In some implementations, the set of camera poses are defined in a relative coordinate system.

In some implementations, the method further includes using an initialization process to orient an initial group of camera poses of the set of camera poses to a Manhattan modeling system, to obtain a Manhattan offset, and subsequently propagating the Manhattan offset to other camera poses of the set of camera poses.

In some implementations, the method further includes creating an additional subset of camera poses when new drift is detected in an additional camera within the subset of camera poses.

In some implementations, the method further includes correcting accuracy issues in the at least one image markup by computing covariances of estimated points.

In some implementations, the method further includes obtaining multiple image markups on the visual data of the at least one associated image, and distributing the multiple markups around the visual data to avoid overfitting when markups are in one place in which case data is likely biased towards that region.

In some implementations, the method further includes obtaining multiple image markups on visual data of multiple images associated with the subset of camera poses, and applying markups that identify features observed in more than one image, such that camera parameter adjustments are not biased towards features that are not observed in other images.

In some implementations, the constrained degree of freedom is based on a gravity vector associated with the at least one camera pose. The gravity vector refers to up and down for the scene. In some implementations, the z-axis is constrained. Constraining refers to fixing a degree of freedom when other parameters are adjusted.

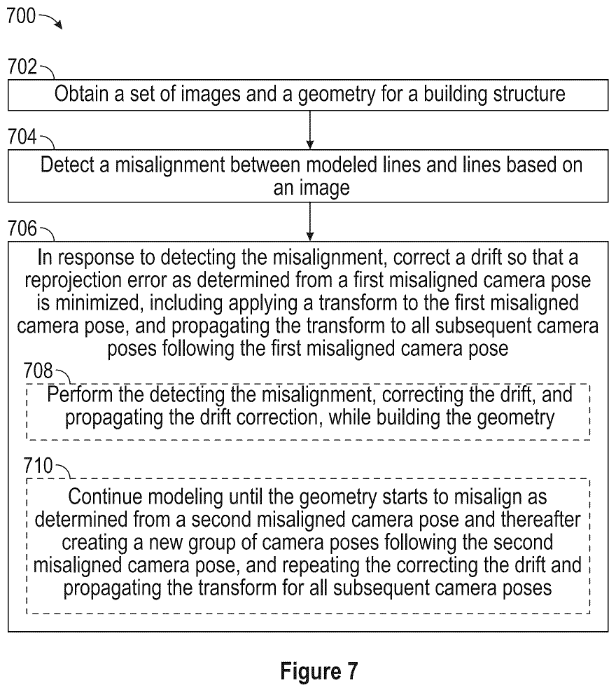

FIG. 7 is a flowchart of another example method 700 for drift detection and correction, in accordance with some implementations. The method 700 is performed in a computing device (e.g., the device 108 and one or more modules of the drift detection and correction modules 214). The method can be used to detect and/or correct drifts in images obtained from visual inertial odometry.

The method includes obtaining (702) a set of images and a geometry for a building structure.

The method also includes detecting (704) a misalignment between modeled lines and lines based on an image.

The method also includes, in response to detecting the misalignment, correcting (706) a drift so that a reprojection error as determined from a first misaligned camera pose is minimized, including applying a transform to the first misaligned camera pose, and propagating the transform to all subsequent camera poses following the first misaligned camera pose.

In some implementations, the detecting the misalignment, correcting the drift, and propagating the drift, are performed (708) while building the geometry.

In some implementations, the method further includes continuing (710) modeling until the geometry starts to misalign as determined from a second misaligned camera pose and thereafter creating a new group of camera poses following the second misaligned camera pose, and repeating the correcting the drift and propagating the transform for all subsequent camera poses.

Accurate camera pose estimation is essential during capture for detecting and fixing problems in real-time, before reconstruction for building match graphs and determining scale, and after modeling for AR model scaling and virtual walkthrough registration. For virtual walkthrough applications, AR poses can be used to determine the placement of Apple Object Capture (AOC) mesh on a CAD model. AR tracking provides essential pose data for all these use cases. For example, AR tracking provides useful initialization for solving cameras. AR tracking can help inform which pairs of images to use for feature matching, so feature matching can avoid matching every possible pair. However, AR tracking accuracy cannot be guaranteed due to potential drift, necessitating methods to identify and utilize only reliable portions of AR tracking data.

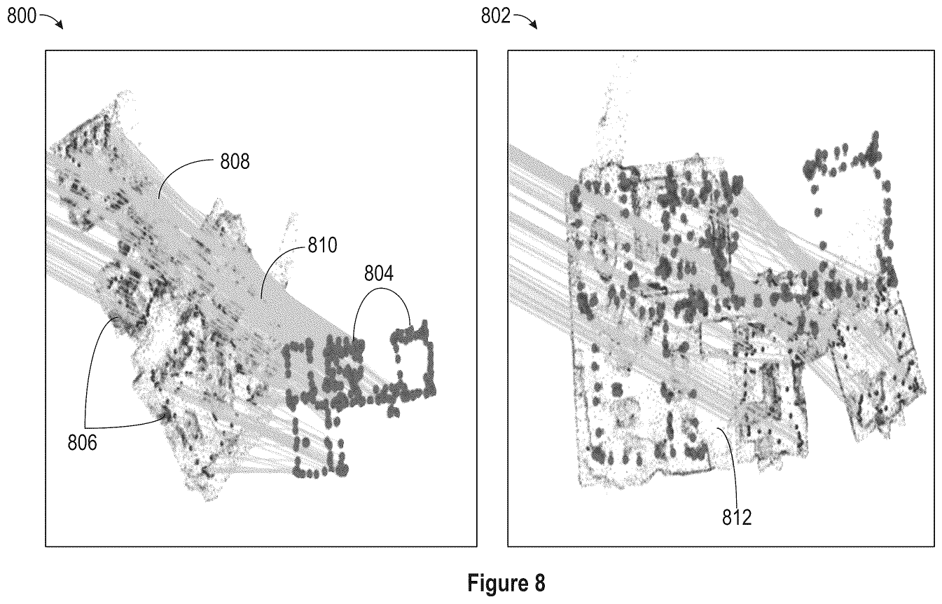

FIG. 8 is a schematic diagram illustrating the use of AR poses for registering a first set of poses with a second set of poses, according to some implementations. In some examples, the first set of poses may be from an initial capture and the second set of poses may be from a reconstruction system, such as AOC. In some examples, the first set of poses may be from a first reconstruction system, such as AOC, and the second set of poses may be from a second reconstruction system, such as a modeler-based reconstruction. The illustration 800 on the left shows first poses 804, for example representing initially captured poses (e.g., AR poses), and second poses 806, for example representing solved cameras/poses, such as from AOC and/or a CAD modeling process. The illustration 802 on the right shows placement of the first poses 804 on top of the second poses 806. Alignment between the first poses 804 and the second poses 806 may be indicative of the consistency between AR pose tracking/estimation techniques. For the example shown, despite both methods missing different rooms (e.g., poses 806 miss room 810, and poses 804 miss room 812), the system successfully identified the largest inlier group, enabling correct placement of the first poses 804 with respect to the second poses 806. When combined with modeler solved poses (e.g., additional poses), this alignment produces optimal results for the captured space. This example shows how AR pose data, when working correctly, can help bridge the gap between various pose sets such as the initially captured poses, the AOC poses, and the sparse solved poses from modeler, and complete spatial reconstruction.

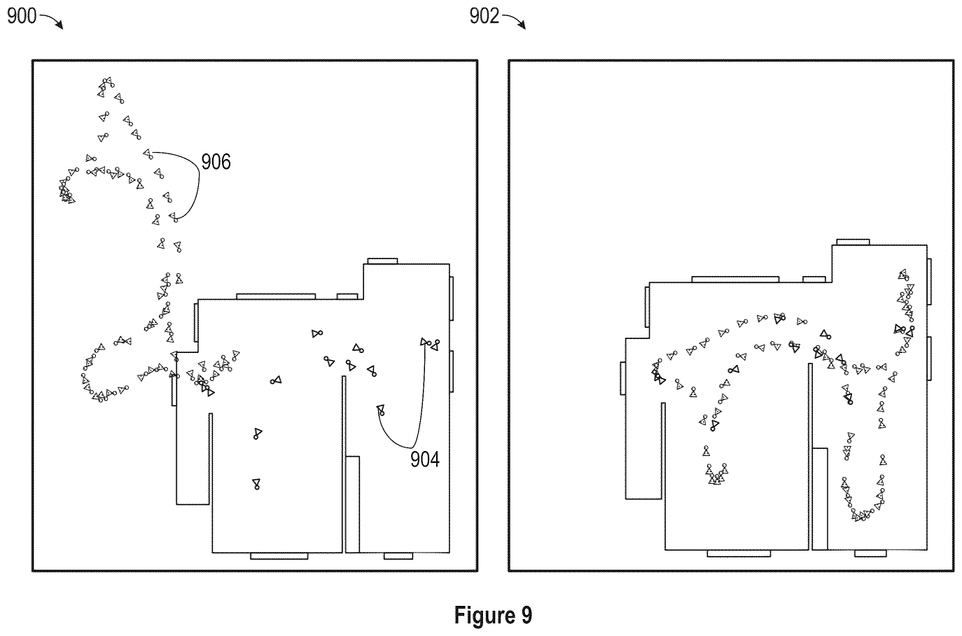

FIG. 9 is a schematic diagram illustrating an example of a case of camera pose alignment, according to some implementations. The illustration 900 on the left shows first poses 904, for example representing solved cameras/poses, such as from AOC and/or a CAD modeling process, overlaid on a CAD model of a building, and second poses 906, for example representing initially captured poses (e.g., AR poses). The illustration 902 on the right shows placement of the second poses 906 over the first poses 904. This example demonstrates a scenario where solved cameras (e.g., the first poses 904) align nearly perfectly with AR tracking data (e.g., the second poses 906), representing an ideal outcome in the pose estimation process. This alignment is significant as it validates the accuracy of both the AR tracking system and the solved camera poses, providing a reliable foundation for subsequent reconstruction and modeling steps. Such alignment is particularly valuable for virtual walkthroughs, as it ensures accurate spatial relationships between the captured data and the final 3D model. The diagram serves as a reference case for evaluating the quality of pose estimations in other scenarios where alignment may be less precise.

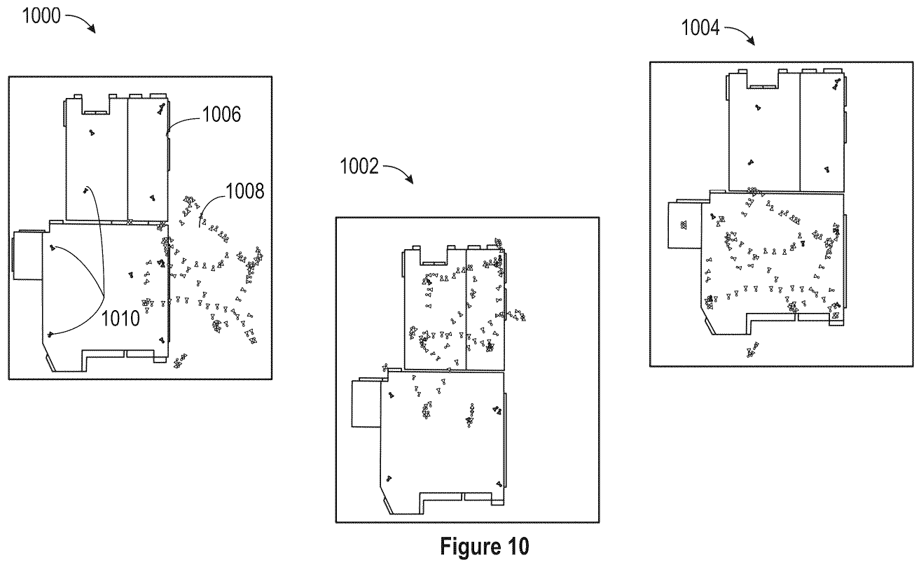

FIG. 10 is a schematic diagram illustrating the challenges of AR tracking drift in pose registration between pose sets, according to some implementations. The illustration 1000 shows a CAD model 1006 of a building. First poses 1008, for example representing initially captured poses (e.g., AR poses) or solved camera poses from AOC, and second poses 1010, for example representing solved cameras/poses, such as from a CAD modeling process, are shown on the right. Poor AR tracking compromises the alignment of the otherwise well-reconstructed mesh. In this case, the pose registration system must attempt to align pose groups 1008 and 1010, where choosing either group fails to produce a correct transform for the other. When the aligner treats the entire capture as a single rigid group, it can only satisfy one side of the capture (e.g., either the side shown in the illustration 1002 or the side shown in the illustration 1004), resulting in misalignment of the entire space. This misalignment can also occur if one half of the poses may be used to register AR poses to CAD poses while the other half may be used to register AOC poses to AR poses, leading to complete spatial misalignment. Even if such failures represent a minority of cases, they can significantly impact reconstruction quality, sometimes preventing proper alignment. Drift detection can enable the use of reliable portions of AR data, allowing for better estimation of camera positions and ultimately improving reconstruction accuracy.

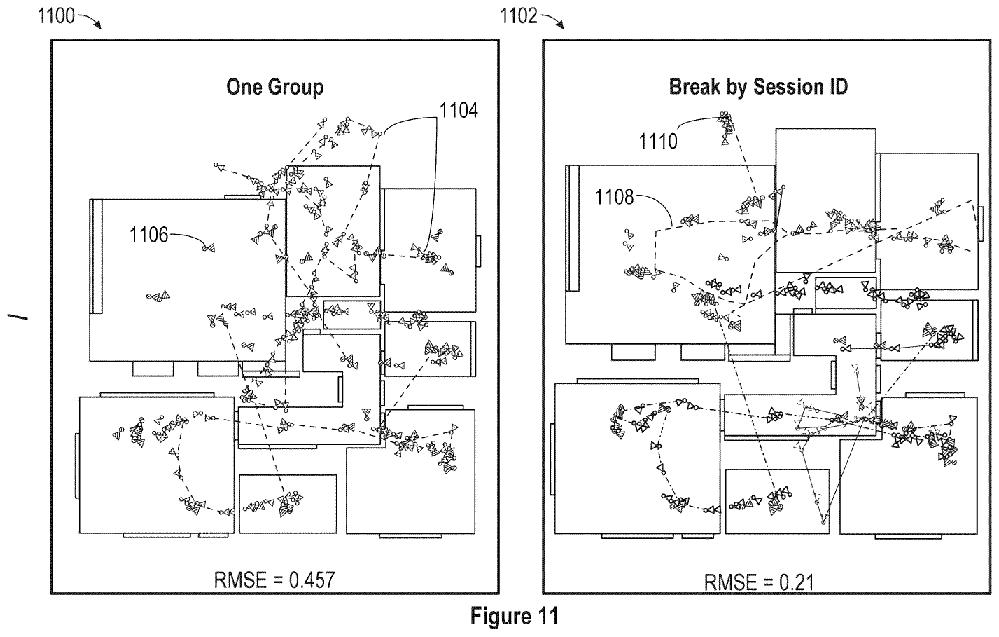

FIG. 11 illustrates example methods for detecting AR tracking drifts in captures, according to some implementations. The illustration 1100 shows camera poses 1106, for example representing solved camera/poses, such as from AOC and/or a CAD modeling process. The dashed lines correspond to one or more groups of camera poses 1104, for example representing initially captured poses (e.g., AR poses) from AR tracking, after an alignment attempt, which shows misaligned poses-several camera poses solved cameras/poses do not have a corresponding AR poses from AR tracking. For this example, test results showed a root mean square error of 0.450, which indicates substantial misalignment. The illustration 1102 on the right shows AR poses from AR tracking broken into groups (e.g., groups 1108 and 1110) based on a session identifier (for AR tracking session). This grouping results in much lower alignment error (a root mean square error of 0.210 for this example). However, excessive breaking of camera poses from AR tracking can also result in loss of good camera poses. So it is preferable to keep the groups as large as possible while getting rid of the rigidity in the camera poses.

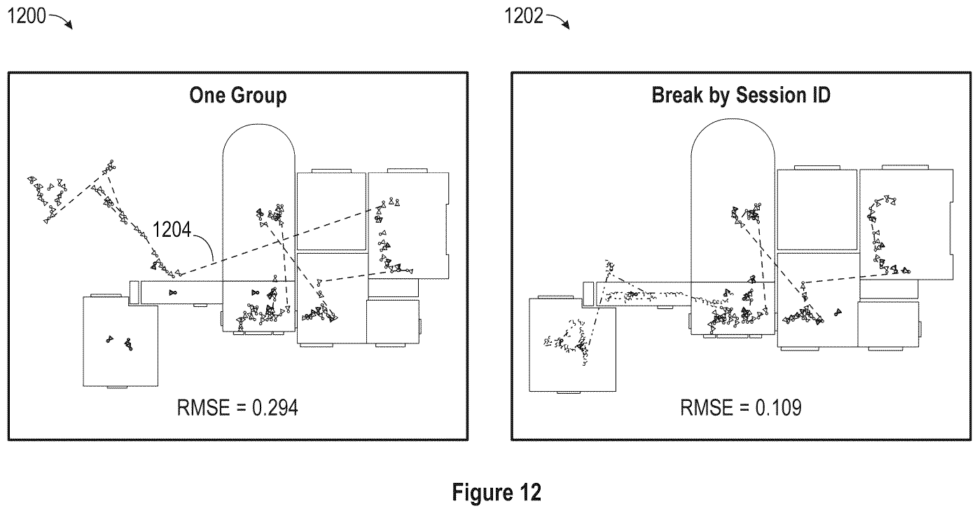

FIG. 12 illustrates an example method for AR drift detection using tracking session identifier, according to some implementations. The illustration 1200 shows a loss of tracking 1204, which is caught by the tracking session identifier. The system can use that information to group the camera poses from AR tracking. For example, the camera poses between tracking session identifiers may be grouped together. The solved poses, for example from a CAD modeling process, can serve as a ground truth for the grouping and the scaffolding for mapping the disparate camera pose groups to the solved poses and/or to one another. For this example, the case on the left (with one group) showed a root mean square error of 0.294, whereas breaking the camera poses by the session identifier (the illustration 1202) showed a root mean square error of 0.109.

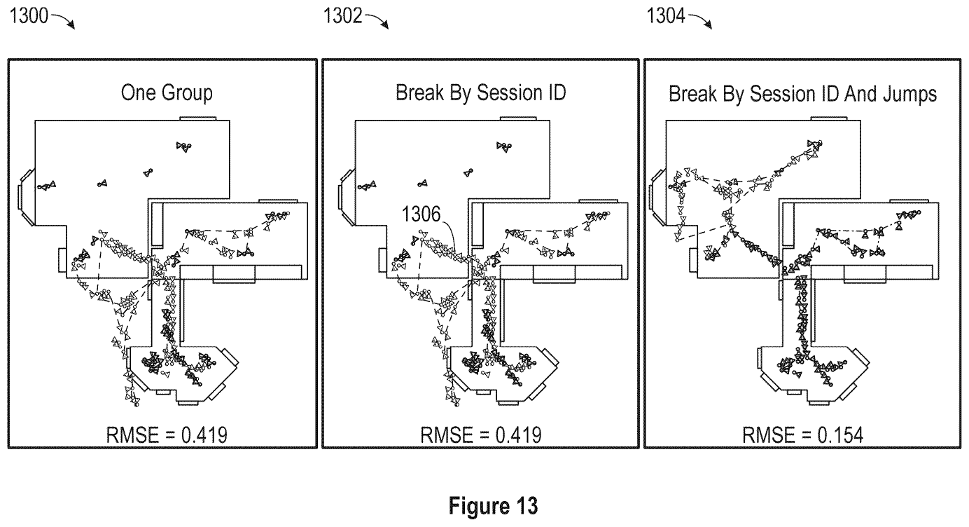

FIG. 13 illustrates example methods for AR drift detection, according to some implementations. The illustration 1300 corresponds to one group (not using session identifiers), which results in substantial misalignment (for this example, the root mean square error was 0.419). The illustration 1302 corresponds to using session identifiers. Because of a break in tracking (e.g., 1306), there is no session identifiers during some time periods. Without the session identifiers, the misalignment persists. The illustration 1304 corresponds to a method of breaking the AR camera poses into groups based on session identifier and detection of unusual movements in the AR camera poses (e.g., acceleration changes, velocity changes, time delays between subsequent poses), which may indicate that the AR tracking cannot be trusted. The illustration 1304 shows substantially better alignment (a root mean square error of 0.154 for this example).

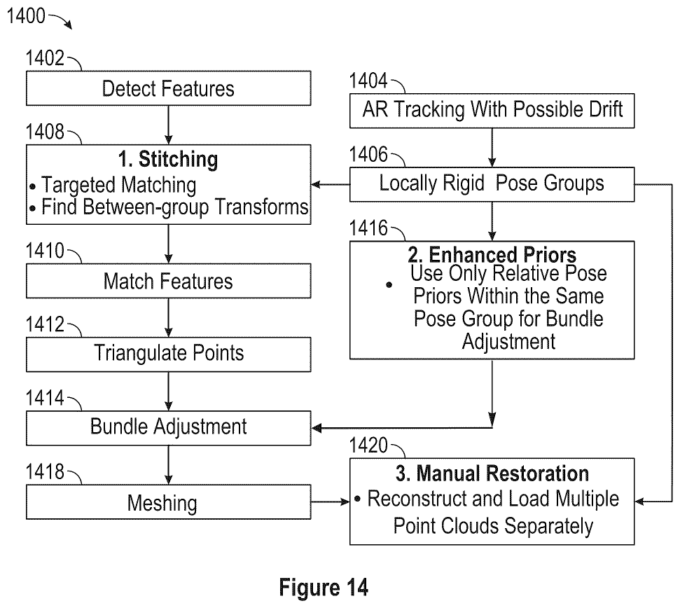

FIG. 14 is a schematic diagram of an example process 1400 for estimating a correct pose, according to some embodiments. AR tracking poses 1404 with possible drifts are used to generate locally rigid pose groups 1406, using the example methods described herein. The locally rigid captured camera pose groups are defined and identified based on the detected inconsistencies (e.g., drifts). Each locally rigid captured camera pose group includes captured camera poses that are grouped according to (e.g., between) the detected inconsistencies. As an example, if there are 100 captured camera poses and there are detected inconsistencies around the 30th captured camera pose and the 50th captured camera pose, the locally rigid captured camera pose groups would be camera poses 1-29, camera poses 30-49, and camera poses 50-100.

An example reconstruction pipeline includes detecting features 1402 in images. This is followed by selecting a set of images corresponding to camera poses within each group of the locally rigid pose groups 1406. Subsequently, feature matching 1410 (e.g., classical feature matching) and triangulation 1412 are used to stitch 1408 the groups together. The stitching 1408 includes targeted matching and determining between-group transforms. The grouping avoids finding a full set of image pairs to match features with.

The reconstruction pipeline can also include bundle adjustment 1414, which includes refining a visual reconstruction to produce jointly optimal structure and viewing parameter estimates. Bundle adjustment can use enhanced priors 1416 based on the locally rigid pose groups 1406. For example, only relative pose priors within the same group are used for bundle adjustment. Some implementations input only the relative priors that are good, which can result in better pose estimates from the reconstruction pipeline. In some implementations, the reconstruction pipeline includes meshing 1418 the triangulated points to create a 3D surface model. Some implementations include manual restoration 1420, which can include separately reconstructing point clouds for each group. This step can enable a modeler to move around different point clouds.

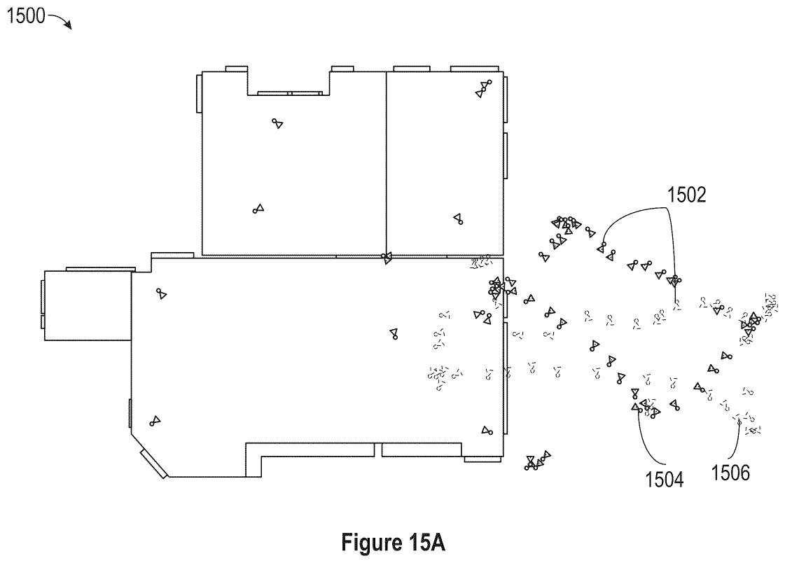

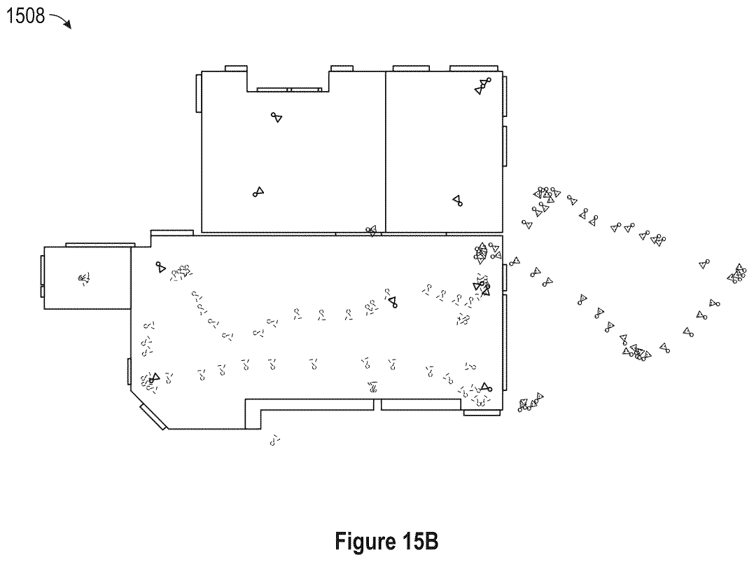

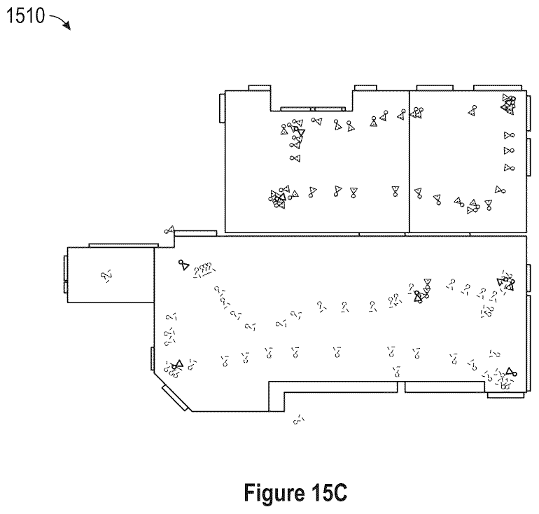

FIGS. 15A-15C illustrate an example application of drift detection using locally rigid pose groups, according to some implementations. The illustration 1500 (FIG. 15A) shows AR camera poses 1502, which are separated into two groups 1504 and 1506 based on session identifier and/or detection of abnormalities (e.g., unusual movements, such as acceleration changes, velocity changes, time delays between subsequent poses) in the AR camera poses. The illustration 1508 (FIG. 15B) shows a successful alignment attempt using the group 1506, and the illustration 1510 (FIG. 15C) shows another successful alignment attempt using the group 1504.

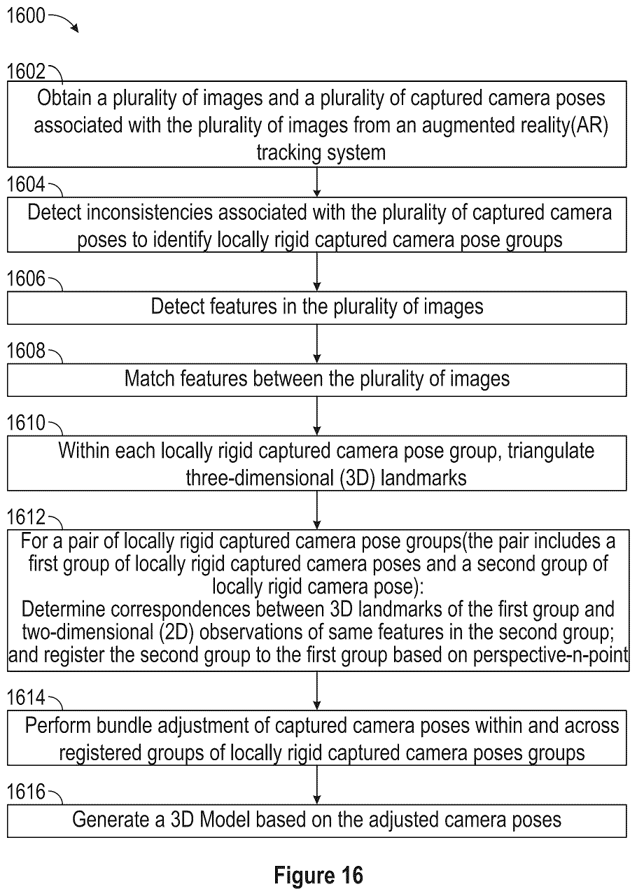

FIG. 16 is a flowchart of an example method 1600 for detecting and correcting drift in camera poses, in accordance with some implementations. The method 1600 is performed in a computing device (e.g., the device 108 and one or more modules of the drift detection and correction modules 214).

The method includes obtaining (1602) a plurality of images and a plurality of captured camera poses associated with the plurality of images from an augmented reality (AR) tracking system.

The method includes detecting (1604) inconsistencies associated with the plurality of captured camera poses (sometimes referred to as detecting drifts in the camera poses) to identify locally rigid captured camera pose groups. In some implementations, detecting inconsistencies includes detecting a change in tracking session identification associated with the plurality of captured camera poses. In some implementations, detecting inconsistencies includes detecting a change in tracking session state associated with the plurality of captured camera poses. In some implementations, detecting inconsistencies includes detecting a translational acceleration exceeding a translational acceleration threshold. In some implementations, the translational acceleration threshold is five meters per second squared. In some implementations, detecting inconsistencies includes detecting a rotational acceleration exceeding a rotational acceleration threshold. In some implementations, the rotational acceleration threshold is ten radians per second squared. In some implementations, detecting inconsistencies includes detecting a translational velocity exceeding a translational velocity threshold. In some implementations, the translation velocity threshold is two meters per second. In some implementations, detecting inconsistencies includes detecting a rotational velocity exceeding a rotational velocity threshold. In some implementations, the rotational velocity threshold is three radians per second.

The method also includes detecting (1606) features in the plurality of images.

The method also includes matching (1608) features between the plurality of images. For captured camera poses in a locally rigid captured camera pose group, the method generates pairs of captured camera poses in the locally rigid captured camera pose group and matches features between the pairs of captured camera poses. For captured camera poses across locally rigid captured camera pose groups, the method generates pairs of captured camera poses and matches features between the pairs of captured camera poses.

The method also includes, within each locally rigid captured camera pose group, triangulating (1610) three-dimensional (3D) landmarks. Each landmark includes a 3D point and a plurality of 2D points of images that correspond to the 3D point.

The method also includes, for a pair of locally rigid captured camera pose groups that includes a first group of locally rigid captured camera poses and a second group of locally rigid camera poses, in step 1612: determining correspondences between 3D landmarks of the first group and two-dimensional (2D) observations of same features in the second group, and registering the second group to the first group based on perspective-n-point.

The method also includes performing (1614) bundle adjustment of captured camera poses within and across registered groups of locally rigid captured camera pose groups. In some implementations, performing bundle adjustment within registered groups of locally rigid captured camera pose groups includes using relative pose priors within the same group. In some implementations, performing bundle adjustment includes using captured camera poses of the locally rigid captured camera pose groups as enhanced priors in the bundle adjustment process.

The method also includes generating (1616) a 3D model based on the adjusted camera poses.

In some implementations, the method further includes providing an interface for manual restoration of the 3D model. The interface includes reconstructing and loading multiple point clouds separately. In some implementations, the interface for manual restoration includes tools for adjusting positions of separate point clouds corresponding to different pose groups.

In some implementations, the method further includes meshing the triangulated points to create a 3D surface model.

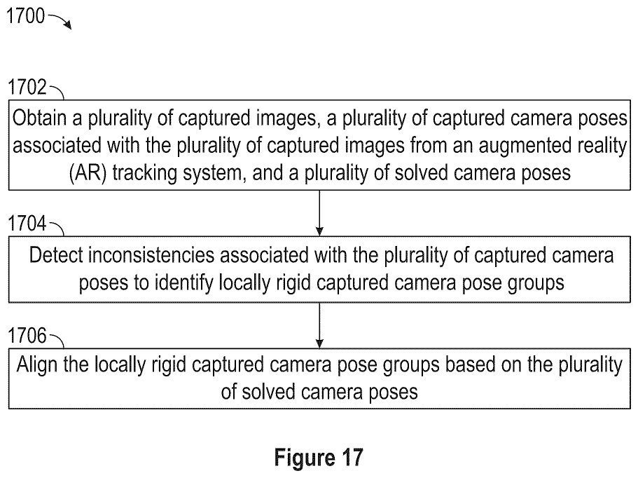

FIG. 17 is a flowchart of another example method 1700 for detecting and correcting drift in camera poses, in accordance with some implementations. The method 1700 is performed in a computing device (e.g., the device 108 and one or more modules of the drift detection and correction modules 214).

The method includes obtaining (1702) a plurality of captured images, a plurality of captured camera poses associated with the plurality of captured images from an augmented reality (AR) tracking system, and a plurality of solved camera poses. In some implementations, the plurality of solved camera poses are associated with a 3D model. In some implementations, the 3D model includes a parametric model. In some implementations, the 3D model includes a point cloud. In some implementations, the 3D model includes a mesh model. In some implementations, the plurality of solved camera poses includes a plurality of camera pose estimates. In some implementations, the plurality of solved camera poses are based on the plurality of captured camera poses. In some implementations, the plurality of solved camera poses includes a subset of the plurality of captured camera poses. In some implementations, the plurality of solved camera poses includes a modified version of the plurality of captured camera poses. In some implementations, the modifications include one or more of position, orientation, and camera intrinsics. In some implementations, the plurality of captured camera poses are temporally sequenced.

The method also includes detecting (1704) inconsistencies associated with the plurality of captured camera poses (sometimes referred to as detecting drifts in the camera poses) to identify locally rigid captured camera pose groups. In some implementations, detecting inconsistencies includes detecting a change in tracking session identification associated with the plurality of captured camera poses. In some implementations, detecting inconsistencies includes detecting a change in tracking session state associated with the plurality of captured camera poses. In some implementations, detecting inconsistencies includes detecting a translational acceleration exceeding a translational acceleration threshold. In some implementations, the translational acceleration threshold is five meters per second squared. In some implementations, detecting inconsistencies includes detecting a rotational acceleration exceeding a rotational acceleration threshold. In some implementations, the rotational acceleration threshold is ten radians per second squared. In some implementations, detecting inconsistencies includes detecting a translational velocity exceeding a translational velocity threshold. In some implementations, the translation velocity threshold is two meters per second. In some implementations, detecting inconsistencies includes detecting a rotational velocity exceeding a rotational velocity threshold. In some implementations, the rotational velocity threshold is three radians per second.

The method also includes aligning (1706) the locally rigid captured camera pose groups based on the plurality of solved camera poses. In some implementations, aligning the locally rigid captured camera pose groups includes aligning each locally rigid captured camera pose group to the plurality of solved camera poses. In some implementations, aligning the locally rigid captured camera pose groups includes performing operations for each locally rigid captured camera pose group. The operations include identifying corresponding solved camera poses of the plurality of solved camera poses. The operations include generating a transform for aligning the locally rigid captured camera pose group to the corresponding solved camera poses. The operations include applying the transform to the locally rigid captured camera pose group to align the locally rigid camera pose group to the corresponding solved camera poses. In some implementations, the transform includes a similarity transform between a world coordinate system of the locally rigid captured camera pose group and a world coordinate system of the plurality of solved camera poses. In some implementations, the similarity transform includes one or more of rotation, translation, and scaling.

In some implementations, the method further includes generating a 3D model based on the aligned locally rigid captured camera pose groups. In some implementations, the 3D model includes a parametric model. In some implementations, the 3D model includes a point cloud. In some implementations, the 3D model includes a mesh model.

In some implementations, the method further includes obtaining a model, detecting a drift in at least one camera pose of an aligned locally rigid captured camera pose group, and correcting the drift of the at least one camera pose based on the model.

In this way, the techniques provided herein detect and/or correct drifts in images obtained from visual inertial odometry.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for detecting and correcting drift in camera poses, the method comprising:
obtaining a plurality of images and a plurality of captured camera poses associated with the plurality of images from an augmented reality (AR) tracking system;
detecting inconsistencies associated with the plurality of captured camera poses to identify locally rigid captured camera pose groups;
detecting features in the plurality of images;
matching features between the plurality of images, wherein matching features comprises:
for captured camera poses in a locally rigid captured camera pose group, generating pairs of captured camera poses in the locally rigid captured camera pose group and matching features between the pairs of captured camera poses; and
for captured camera poses across locally rigid captured camera pose groups, generating pairs of captured camera poses and matching features between the pairs of captured camera poses;
within each locally rigid captured camera pose group, triangulating three-dimensional (3D) landmarks, wherein each landmark comprises a 3D point and a plurality of 2D points of images that correspond to the 3D point;
for a pair of locally rigid captured camera pose groups, wherein the pair includes a first group of locally rigid captured camera poses and a second group of locally rigid camera poses:
determining correspondences between 3D landmarks of the first group and two-dimensional (2D) observations of same features in the second group; and
registering the second group to the first group based on perspective-n-point;
performing bundle adjustment of captured camera poses within and across registered groups of locally rigid captured camera pose groups; and
generating a 3D model based on the adjusted camera poses.

2. The method of claim 1, wherein detecting inconsistencies comprises detecting a change in tracking session identification associated with the plurality of captured camera poses.

3. The method of claim 1, wherein detecting inconsistencies comprises detecting a change in tracking session state associated with the plurality of captured camera poses.

4. The method of claim 1, wherein detecting inconsistencies comprises detecting a translational acceleration exceeding a translational acceleration threshold.

5. The method of claim 4, wherein the translational acceleration threshold is five meters per second squared.

6. The method of claim 1, wherein detecting inconsistencies comprises detecting a rotational acceleration exceeding a rotational acceleration threshold.

7. The method of claim 6, wherein the rotational acceleration threshold is ten radians per second squared.

8. The method of claim 1, wherein detecting inconsistencies comprises detecting a translational velocity exceeding a translational velocity threshold.

9. The method of claim 8, wherein the translation velocity threshold is two meters per second.

10. The method of claim 1, wherein detecting inconsistencies comprises detecting a rotational velocity exceeding a rotational velocity threshold.

11. The method of claim 10, wherein the rotational velocity threshold is three radians per second.

12. The method of claim 1, wherein performing bundle adjustment within registered groups of locally rigid captured camera pose groups comprises using relative pose priors within the same group.

13. The method of claim 1, wherein performing bundle adjustment comprises using captured camera poses of the locally rigid captured camera pose groups as enhanced priors in the bundle adjustment process.

14. The method of claim 1, further comprising:
providing an interface for manual restoration of the 3D model, including reconstructing and loading multiple point clouds separately.

15. The method of claim 14, wherein the interface for manual restoration comprises tools for adjusting positions of separate point clouds corresponding to different pose groups.

16. The method of claim 1, further comprising:
meshing the triangulated points to create a 3D surface model.

17. A system for detecting and correcting drift in camera poses, comprising:
one or more processors;
memory storing instructions that, when executed by the one or more processors, cause the system to perform a method comprising:
obtaining a plurality of images and a plurality of captured camera poses associated with the plurality of images from an augmented reality (AR) tracking system;
detecting inconsistencies associated with the plurality of captured camera poses to identify locally rigid captured camera pose groups;
detecting features in the plurality of images;
matching features between the plurality of images, wherein matching features comprises:
for captured camera poses in a locally rigid captured camera pose group, generating pairs of captured camera poses in the locally rigid captured camera pose group and matching features between the pairs of captured camera poses; and
for captured camera poses across locally rigid captured camera pose groups, generating pairs of captured camera poses and matching features between the pairs of captured camera poses;
within each locally rigid captured camera pose group, triangulating three-dimensional (3D) landmarks, wherein each landmark comprises a 3D point and a plurality of 2D points of images that correspond to the 3D point;
for a pair of locally rigid captured camera pose groups, wherein the pair includes a first group of locally rigid captured camera poses and a second group of locally rigid camera poses:
determining correspondences between 3D landmarks of the first group and two-dimensional (2D) observations of same features in the second group; and
registering the second group to the first group based on perspective-n-point;
performing bundle adjustment of captured camera poses within and across registered groups of locally rigid captured camera pose groups; and
generating a 3D model based on the adjusted camera poses.

18. The system of claim 17, wherein detecting inconsistencies comprises detecting at least one of: a change in tracking session identification associated with the plurality of captured camera poses, a change in tracking session state associated with the plurality of captured camera poses, a translational acceleration exceeding a translational acceleration threshold, a rotational acceleration exceeding a rotational acceleration threshold, and a translational velocity exceeding a translational velocity threshold.

19. The system of claim 17, wherein performing bundle adjustment within registered groups of locally rigid captured camera pose groups comprises using relative pose priors within the same group, and using captured camera poses of the locally rigid captured camera pose groups as enhanced priors in the bundle adjustment process.

20. One or more non-transitory computer-readable media storing instructions for detecting and correcting drift in camera poses that, when executed by a system comprising one or more processors, cause the one or more processors to perform operations comprising:
obtaining a plurality of images and a plurality of captured camera poses associated with the plurality of images from an augmented reality (AR) tracking system;
detecting inconsistencies associated with the plurality of captured camera poses to identify locally rigid captured camera pose groups;
detecting features in the plurality of images;
matching features between the plurality of images, wherein matching features comprises:
for captured camera poses in a locally rigid captured camera pose group, generating pairs of captured camera poses in the locally rigid captured camera pose group and matching features between the pairs of captured camera poses; and
for captured camera poses across locally rigid captured camera pose groups, generating pairs of captured camera poses and matching features between the pairs of captured camera poses;
within each locally rigid captured camera pose group, triangulating three-dimensional (3D) landmarks, wherein each landmark comprises a 3D point and a plurality of 2D points of images that correspond to the 3D point;
for a pair of locally rigid captured camera pose groups, wherein the pair includes a first group of locally rigid captured camera poses and a second group of locally rigid camera poses:
determining correspondences between 3D landmarks of the first group and two-dimensional (2D) observations of same features in the second group; and
registering the second group to the first group based on perspective-n-point;
performing bundle adjustment of captured camera poses within and across registered groups of locally rigid captured camera pose groups; and
generating a 3D model based on the adjusted camera poses.
